(19) United States
(12) Patent Application Publication
(10) Pub. No.: US 2017/0046646 A1
(43) Pub. Date: Feb. 16, 2017

(54) SECURE TIME-TO-LIVE

(71) Applicant: Wickr Inc., Chicago, IL (US)

(72) Inventors: Lauren Wakefield, Union, NJ (US); Robert Statica, Flanders, NJ (US); Christopher A. Howell, Freehold, NJ (US); Kara Lynn Coppa, Flanders, NJ (US)

(21) Appl. No.: 15/009,818

(22) Filed: Jan. 28, 2016

Related U.S. Application Data
(63) Continuation of application No. 14/871,935, filed on Sep. 30, 2015.
Application No. 14/871,935 is a continuation-in-part of application No. 14/314,018, filed on Jun. 24, 2014.
(60) Provisional application No. 61/839,307, filed on Jun. 25, 2013.
(60) Provisional application No. 61/846,568, filed on Jul. 15, 2013.
(60) Provisional application No. 61/943,826, filed on Feb. 24, 2014.

(51) Int. Cl. G06Q 10/06; H04L 12/58

(52) U.S. Cl. CPC G06Q 10/06314; H04L 51/18

(57) ABSTRACT

Techniques for determining whether to allow access to a calendar invite and a meeting are disclosed. In this regard, a calendar invite and meeting message are received from a sender. A first time-to-live (TTL) value and a second TTL value associated with the calendar invite and meeting, respectively, are determined. A determination is made that the first and second TTL values have not been exceeded and, if they have not, allowing access to the calendar invite and the meeting. However, when the TTL values have been exceeded, denying access to the calendar invite and the meeting.

### CROSS REFERENCE TO OTHER APPLICATIONS

This application is a continuation of co-pending U.S. patent application Ser. No. 14/871,935, entitled SECURE TIME-TO-LIVE filed Sep. 30, 2015 which is incorporated herein by reference for all purposes, which is a continuation in part of co-pending U.S. patent application Ser. No. 14/314,018 entitled SECURE TIME-TO-LIVE filed Jun. 24, 2014 which is incorporated herein by reference for all purposes. U.S. patent application Ser. No. 14/314,018 claims priority to U.S. Provisional Patent Application No. 61/839,307 entitled SECURE TIME TO LIVE filed Jun. 25, 2013, U.S. Provisional Patent Application No. 61/846,568 entitled DIGITAL SECURITY BUBBLE filed Jun. 15, 2013, and U.S. Provisional Patent Application No. 61/943,826 entitled ENHANCED PERFECT FORWARD SECRECY FOR MULTI-SYNCHRONOUS COMMUNICATION filed Feb. 24, 2014, all of which are incorporated herein by reference for all purposes.

### BACKGROUND OF THE INVENTION

Users of electronic devices increasingly desire to communicate privately and securely with one another. Unfortunately, existing approaches to securing communications can be difficult and/or cumbersome to use. As one example, some approaches to data security make use of digital certificates or keys, or pre-shared passwords, which can be tedious to manage. Further, existing approaches are often susceptible to interception (e.g., eavesdropping and man-in-the middle attacks), forensic analysis, and impersonation. Improvements to digital communication techniques are therefore desirable.

### BRIEF DESCRIPTION OF THE DRAWINGS

Various embodiments of the invention are disclosed in the following detailed description and the accompanying drawings.

FIG. 1A illustrates an embodiment of an environment in which the exchange of secure communications is facilitated by a security platform.

FIG. 1B illustrates an embodiment of an environment in which the security platform integrates with a productivity server.

FIG. 2A illustrates an embodiment of an installation and registration process.

FIGS. 2B and 2C illustrate processes for generating a pool of keypairs.

FIGS. 3A and 3B illustrate examples of a messaging interface.

FIG. 4 illustrates an example of composing an email according to one embodiment.

FIG. 5 illustrates an example of composing a meeting request according to one embodiment.

FIG. 6 illustrates an example of a message sending process.

FIG. 7 illustrates an example of a digital security bubble.

FIG. 8 illustrates an example of a digital security bubble.

FIG. 9 illustrates an example of a portion of a digital security bubble.

FIG. 10 illustrates an example of a portion of a digital security bubble.

FIG. 11 illustrates an example of a portion of a digital security bubble.

FIG. 12 illustrates an example of a process for accessing a message included inside a digital security bubble.

FIG. 13 illustrates an example of a process for sending a message.

FIG. 14 illustrates an example of a process for performing a synchronous key cache update.

FIG. 15 illustrates an example of a process for performing an asynchronous key cache update.

FIG. 16 illustrates an embodiment of a message viewing interface.

FIG. 17 illustrates an embodiment of a message viewing interface.

FIG. 18 illustrates an embodiment of an email viewing interface.

FIGS. 19A and 19B illustrate an embodiment of viewing a meeting.

FIG. 20 illustrates an example of a process for determining whether to allow access to a message.

FIG. 21 illustrates an example of a process for determining whether to allow access to a message.

FIG. 22 illustrates an example of a process for determining whether to allow access to a message.

FIG. 23 illustrates an example of a process for determining whether to allow access to a meeting request.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

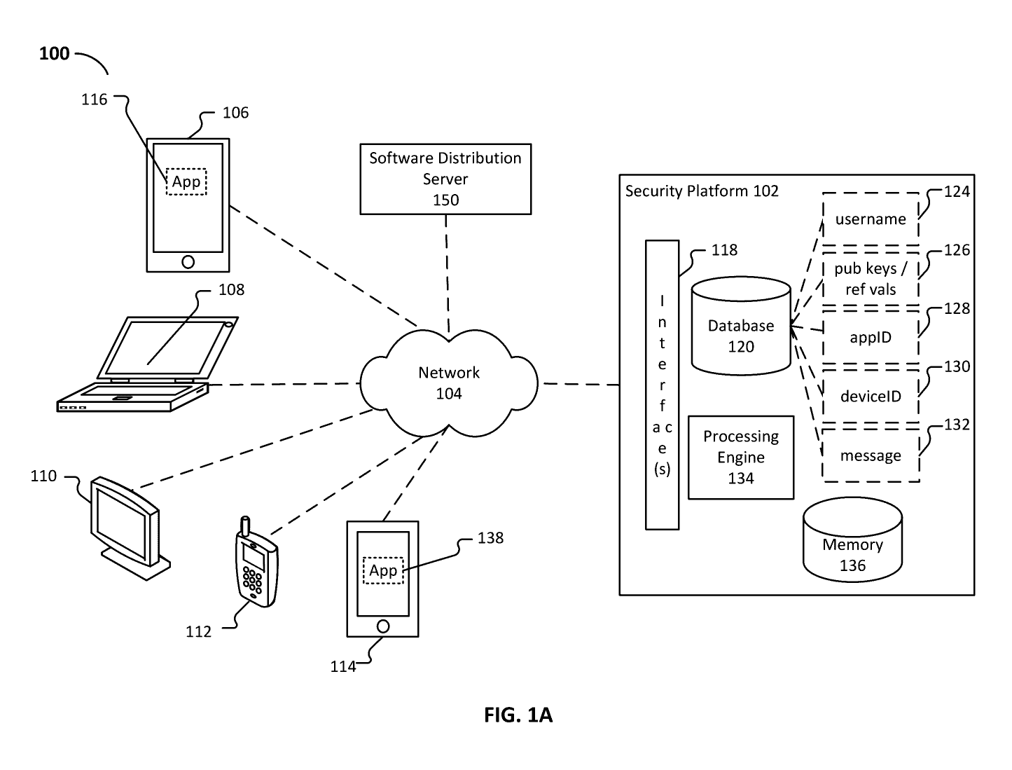

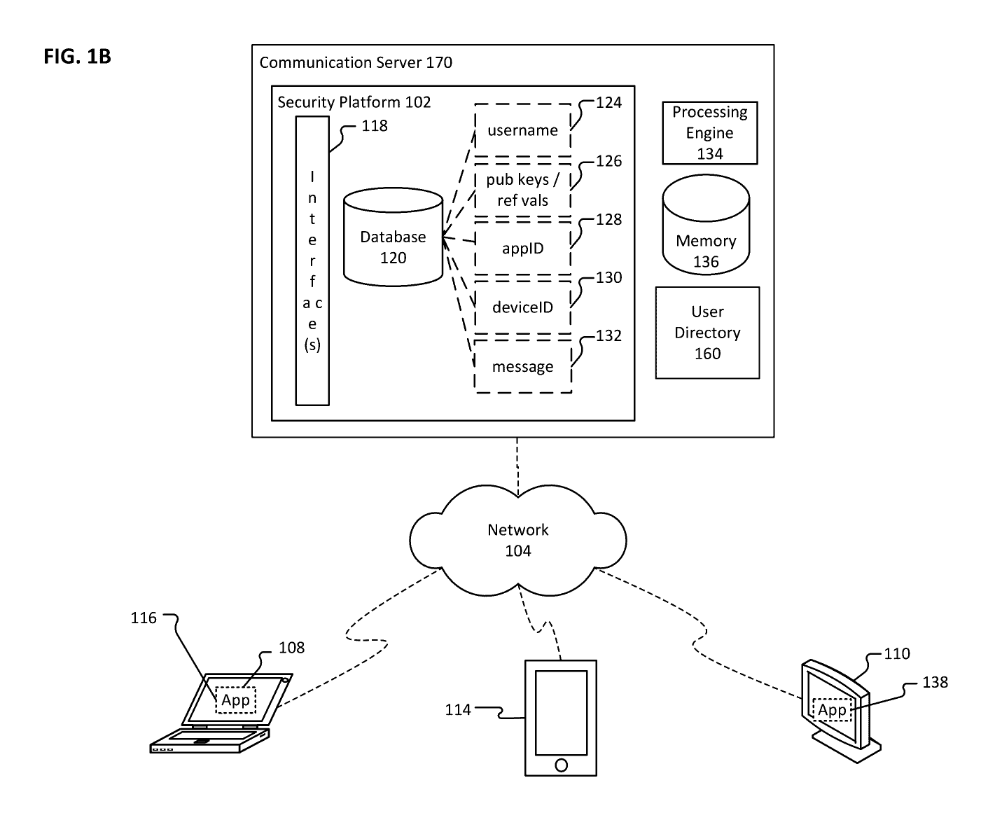

FIG. 1A illustrates an embodiment of an environment in which the exchange of secure communications is facilitated by a security platform (e.g., security platform 102). In the environment shown in FIG. 1, a “digital security bubble” (DSB), described in more detail below, encapsulates or is otherwise provided around a message. The DSB allows information such as encryption information, hardware binding information, message security controls, and decryption information—for multiple recipients (as applicable)—to securely travel with the message. Further, the DSB provides cross-platform support. For example, techniques described herein can be deployed on a variety of operating systems (e.g., Linux, iOS, and Windows), on a variety of smart phone platforms (e.g., iPhone, Android, Windows, Blackberry, etc.), and on a variety of device types (e.g., mobile smart phones, tablets, laptops, desktops, etc.). Using techniques described herein, only intended accounts on intended devices are able to decrypt the messages. Thus, for example, the security platform is unable to decrypt messages. As will be described in more detail below, using the techniques described herein, message participants can maintain a forward secret secure messaging channel, whether communicating synchronously (e.g., where all participants are online or otherwise able to communicate with platform 102) and asynchronously (e.g., where at least one participant is offline or otherwise not in communication with platform 102).

Users of client devices, such as client devices 106-114 communicate securely with one another using techniques described herein. As shown in FIG. 1, client devices include personal computers (110), laptop computers (108), tablets (106), and mobile telephony devices (112, 114). Some client devices, e.g., tablet device 106, make use of techniques described herein via a messaging application (also referred to as an “app”) obtained from a software distribution server 150. Examples of software distribution servers (which can comprise a single server or multiple servers working in cooperation) include app stores (e.g., provided by Apple, Google, Blackberry, Microsoft, Amazon, and/or other entities) and other webservers offering app (and/or other software) downloads. Client devices can also make use of a web interface (e.g., provided by platform 102) instead of or in addition to a dedicated messaging application installed on the device. Other types of devices not depicted in FIG. 1 can also be used in conjunction with the techniques described herein, such as game consoles, camera/video recorders, video players (e.g., incorporating DVD, Blu-ray, Red Laser, Optical, and/or streaming technologies) and other network-connected appliances, as applicable.

Communications are exchanged via one or more networks (depicted collectively in FIG. 1 as network cloud 104). Such networks can include wired, wireless, cellular, and satellite networks. And, such networks can be closed/private networks, as well open networks (e.g., the Internet). Further, as used herein, “communications” and “messages” can take a variety of forms, including: e-mails, calendar invites, meeting requests, text messages, documents, audiovisual files, SMSes, MMSes, and voice and video calls. Further, in addition to personal, business, or other types of conversations, the content can pertain to electronic transactions such as credit card security, password protection, directories, and storage drive protection, video on demand security, online gaming, gambling, electronic distribution of music, videos, documents, online learning systems, databases, cloud storage and cloud environments, bank transactions, voting processes, military communications, security of medical records, communication between medically implanted devices and doctors, etc. As will be described in more detail below, the exchange of communications is facilitated by security platform 102 (or embodiments thereof, as applicable).

As will be described in more detail below, a variety of entities can operate embodiments of platform 102. Further, multiple embodiments of platform 102 can exist simultaneously in an environment (with those multiple embodiments operated by a single entity, or different entities) with the techniques described herein adapted as applicable. For example, platform 102 can be operated by a non-profit organization (or an individual, a company, or any other appropriate type of entity or set of entities) for use by the general public (e.g., with arbitrary members of the public able to use platform 102 to exchange communications). As another example, an enterprise organization can operate an embodiment of platform 102 exclusively for use by the employees of the enterprise (and, as applicable, other individuals, such as vendors). As yet another example, a company (or other entity or entities) can operate one or multiple instances of platform 102 on behalf of multiple organizations, such as small business or companies, schools, charitable organizations, etc.

Alternatively, the functionality of the security platform 102 may be integrated into existing communication platforms to provide privacy and security. FIG. 1B illustrates an embodiment of security platform 102 integrated into an existing communication platform. As used herein, communication platforms include instant messaging platforms, such as Cisco Jabber or Microsoft Lync, or productivity tools, such as Microsoft Office or Lotus Notes. Thus, security platform 102 may enable enterprise employees to send secure emails, instant messages, text messages (e.g. SMSes, MMSes), calendar invites, meeting requests, etc. According to some embodiments, the security platform may provide additional functionality, including encryption and time-to-live options, to already existing communication platforms.

As shown in FIG. 1B, the security platform 120 may allow users to communicate securely via communication server 170. That is, devices 110 and 114 may be mobile devices that are configured to allow users to send and receive work-related communications, while device 108 may be a computer located within the enterprise's secured network. In this regard, network 104 may include various configurations and use various protocols including the Internet, World Wide Web, intranets, virtual private networks, local Ethernet networks, private networks using communication protocols proprietary to one or more companies, cellular and wireless networks (e.g., WiFi), instant messaging, HTTP and SMTP, and various combinations of the foregoing. Accordingly, the security platform 102 will allow for secure communications between devices using existing communication platforms with increased functionality, such as encryption and a time-to-live (TTL) option, which that is discussed in greater detail below.

### A. Installation/Initialization/Registration

Suppose a user of client device 106 (hereinafter referred to as “Alice”) would like to send a secure message to her friend, Bob (a user of client device 114) in accordance with techniques described herein. In some embodiments, in order to send a message to Bob, Alice first obtains a copy of a messaging application suitable for her device. For example, if Alice's tablet device runs iOS, she could obtain an “app” for her tablet or mobile phone from the Apple App Store (an example of software distribution server 150). Bob similarly obtains an appropriate application suitable for his client device 114 (e.g., an Android-based smartphone) from an appropriate location (e.g., the Google Play store or Amazon Appstore). In some embodiments, client devices make use of a web-based application (e.g., made available by platform 102 through interface 118), instead of, or in addition to, a dedicated installed application.

In embodiments where platform 102 is operated on behalf of specific groups of individuals (e.g., on behalf of employees of a company, students/teachers at a school, company stockholders, members of a club, premium customers, etc.), the app can be obtained from a publicly accessible software distribution server as Alice and Bob do above (e.g., from the Google Play store), can be obtained from a privately operated software distribution server (e.g., made available only to company-issued devices or devices otherwise authorized to communicate with the private server), can be provisioned by support personnel associated with the group (e.g., by being directly installed by the support personnel or included in a device image), etc., as applicable. For example, suppose an embodiment of platform 102 is operated by ACME University on behalf of its students and faculty/staff. As mentioned above, the university can itself operate an embodiment of platform 102, or can contract with a third party to make available the embodiment of platform 102 for university users. Freshmen (and other new students/employees, as applicable) at ACME University can be provided with instructions for downloading and installing an ACME University-specific embodiment of the secure messaging application from a university server in conjunction with their new student orientation. As another example, new employees of Beta Corporation can be issued company phones (and/or other devices such as laptops) with an embodiment of the secure messaging application pre-installed and pre-configured by support personnel for Beta Corporation (e.g., where Beta Corporation operates an embodiment of platform 102 on behalf of its employees and business partners). As yet another example, business partners of Beta Corporation (e.g., vendors) can be provided with instructions for provisioning a Beta Corporation-specific embodiment of the secure messaging application via email, or via a website. And, the Beta Corporation-specific embodiment of the secure messaging application can be made available via email, a website, or any other appropriate mechanism.

In embodiments where platform 102 is integrated into a communication platform, the security platform may be a module that integrates into the communication platform through various interfaces, such as Application Programming Interfaces (APIs). In this regard, the platform 102 may communicate with the communication platform on the server-side and provide updates to the various client devices that execute the client-side communication platform. These updates may provide the encryption and time-to-live functionality to the applications and programs running on the client-side devices. For example, app 116 may be a desktop program, such as Microsoft Outlook, while app 138 may be a corresponding productivity app (e.g., Outlook) on a user's mobile device.

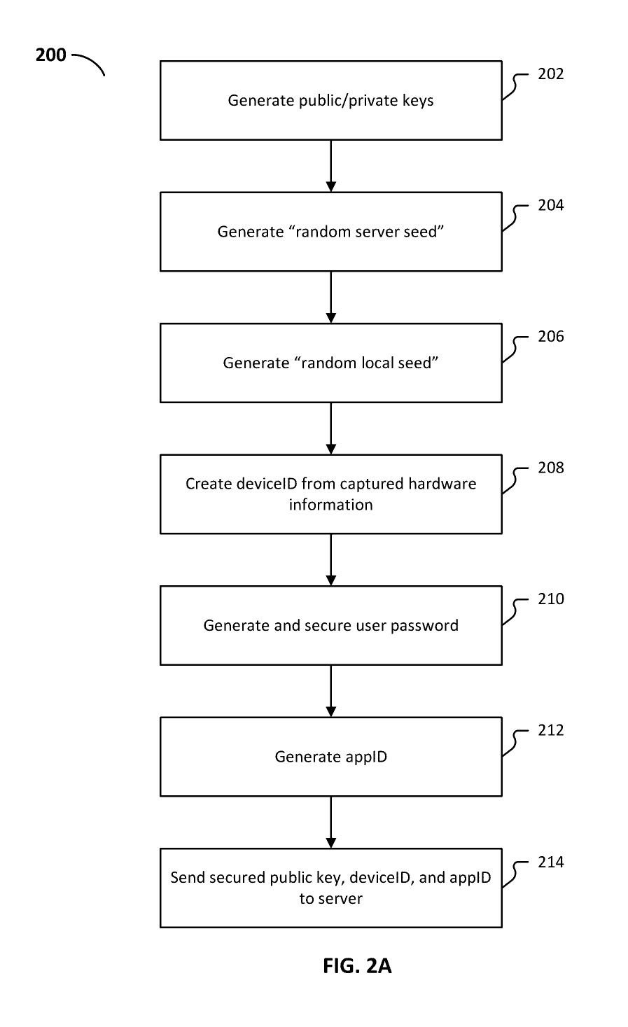

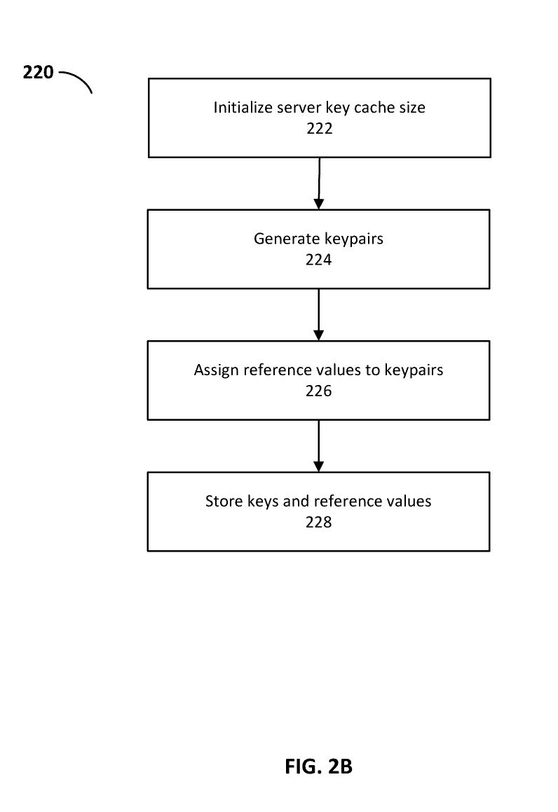

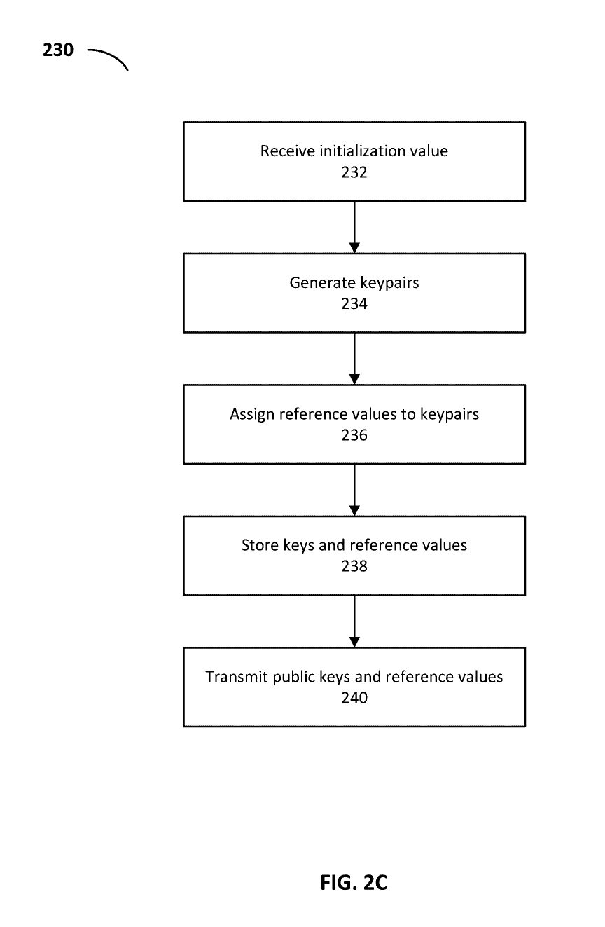

Returning to the example of Alice (a member of the public, using an embodiment of platform 102 made available to the public), once Alice's tablet 106 has obtained a copy of the secure messaging app, the app is installed, and Alice is able to register for an account. An instance of a messaging app usable in conjunction with the techniques described herein is depicted in FIG. 1A as app 116. Examples of events that can occur during an installation/initialization/registration process (200) are illustrated in FIGS. 2A-2C and will now be described. While the events will be described in one order, events can also be performed in other orders and/or in parallel (instead of in sequence) in other embodiments. Further, various events can be added or omitted, in some embodiments, as applicable. For example, where an embodiment of platform 102 is made available by an enterprise for use by its employees (or a school on behalf of its student/staff/faculty, etc.), account creation and initialization may at least partially be performed by support personnel (and/or may be performed at least partially in an automated manner based on a new employee/member workflow), instead of being performed by an end user. As a further example, administrators (e.g., in the school or enterprise scenarios) can pre-configure privacy list information (described in more detail below) on behalf of users. According to embodiments, where the platform 102 is integrated into an existing communication platform, account creation may be performed automatically or by an administrator based on a user directory associated with the communication platform.

In some embodiments, process 200 is performed on a client device, such as Alice's client device 106. The process begins at 202 when a pool of public/private keypairs for the application is generated, on client device 106 (e.g., using RSA, ECDH, or any other appropriate asymmetric encryption algorithms). As one example, the keypairs can be generated using Elliptic Curve Algorithm with Diffie-Helman Key Exchange (ECDH). Other cryptographic standards can also be used, such as RSA. In some embodiments, the keypairs are randomly seeded. As will be described in more detail below, each message Alice sends (whether to Bob or anyone else) can be encrypted with a unique, random key that is used only once then destroyed forensically by Alice (the sender's) device. The forensic destruction ensures that the deleted keys cannot be recovered from Alice's device, even via digital forensics methods.

FIG. 2B illustrates an embodiment of a process for generating a plurality of public/private keypairs. In some embodiments, process 220 is performed on a client device (such as client device 106) as part of step 202 of process 200. Process 220 begins at block 222 when the pool size associated with the client device is initialized. As one example, a default pool size of fifty keys is received as a parameter from platform 102 by application 116. The pool size can also be encoded into application 116 or otherwise provided to device 106 (e.g., configured via an enterprise administrator, where platform 102 is operated on behalf of an enterprise) without requiring the server to transmit the initial pool size. As will be explained in more detail below, the pool size associated with a device can be dynamically adjusted, for example, such that a device (e.g., of a heavy user that is frequently offline) that initially has a pool size of 50 keys can have the size adjusted upward to a pool size of 200 keys (or more).

At block 224, a pool of keys (i.e., a number of keypairs equal to the size initialized at 222) is generated on client device 106. As mentioned above, the keypairs can be generated using Elliptic Curve Algorithm with Diffie-Helman Key Exchange (ECDH). Other cryptographic standards can also be used, such as RSA.

In block 226, a reference value is assigned for each of the respective keypairs. As one example, suppose fifty keypairs are generated at block 224 of process 220. At block 226, fifty respective reference values are assigned to each of the respective keypairs. The reference values will be used to distinguish the various keys in the pool of keys from one another and can be assigned to the keypairs in a variety of ways. As one example, a six digit random number can be generated by device 106 as the first reference value for the first keypair, and each subsequent reference value can be selected as an increment of the first reference value. As another example, every reference value can be randomly selected. Other schemes for selecting/assigning reference values can be employed at block 226 as applicable.

The private keys and reference values are stored (e.g., in a secure database residing on device 106) in block 228. As will be described in more detail below, the corresponding public keys will be transmitted to platform 102 (along with the associated reference values) and platform 102 will designate one of the public keys in the pool as a reserve key. In this regard, the reserve key will be the last key distributed by the platform 102. That is, all of the other keys in the pool of public keys will be used before the reserve key. If the pool of public keys becomes depleted, the reserve key will not be deleted, and instead will be distributed to users until the pool of public keys can be replenished.

Returning to FIG. 2A, a “random server seed” is generated at block 204. In block 206, a “random local seed” is generated. The seeds are used in conjunction with cryptographic key generation, and in some embodiments, the seeds are determined based on captured hardware information (described in more detail below).

In block 208, a device identifier (“deviceID”) is created from captured hardware information, including, for example, hard drive identifiers, motherboard identifiers, CPU identifiers, and MAC addresses for wireless, LAN, Bluetooth, and optical cards. Combinations of information pertaining to device characteristics, such as RAM, CACHE, controller cards, etc., can also be used to uniquely identify the device. Some, or all, of the captured hardware information is run through a cryptographic hash algorithm such as SHA-256, to create a unique deviceID for the device. The captured hardware information can also be used for other purposes, such as to seed cryptographic functions.

In block 210, Alice is asked, via an interface provided by app 116, to supply a desired username. Alice enters “Alice” into the interface. A determination is made as to whether the username is available. As one example, app 116 can supply a cryptographic hash of “Alice” to platform 102 for checking. If platform 102 does not already have a record for that hash, the username “Alice” is available for Alice to use. If platform 102 already has a record of that hash, Alice is instructed by the interface to pick an alternate username. Once Alice has selected an available username, she is asked to supply a password.

As mentioned above, in some embodiments, portions of process 200 may be omitted (or performed by other entities, as applicable). In this regard, the userID portion of block 210 may be skipped for enterprise environments or when the platform is integrated into an existing communications tool. For example, where a university student at ACME University is establishing an account to use an ACME University-specific embodiment of platform 102, the user's name may be preselected or otherwise issued by the University, rather than being selected by the user. Similarly, in a corporate environment, a user's corporate identity or email address may be used as the user ID for the corporate-version of platform 102.

In block 212, an application identifier (“appID”) may be created. The appID is a unique identifier for the particular installation of the messaging app. If Alice installs the messaging app on multiple devices, each of her devices will have its own unique appID. Similarly, each of her devices may also have its own unique deviceID. In some embodiments, the appID may be created by hashing Alice's selected password and other information, such as device information.

Finally, in block 214, Alice's public keys (and reference values), deviceID, and appID are sent to platform 102 in a secure manner. As one example, in some embodiments app 146 may be configured to communicate with platform 102 via TLS.

At the conclusion of process 200, Alice is ready to send and receive secure communications.

As mentioned above, alternate versions of processes 200 and/or 220 can be used in accordance with the techniques described herein. As one example, username/password selection (210) can be performed prior to other portions of process 200 (and can be performed by an entity other than the end user of the messaging application, e.g., where an employer determines a username for an employee). As another example, the random server seed generation (204) and random local seed generation (206) can be performed prior to the keypair generation (202), e.g., with the local seed being used in conjunction with the generating of the keypairs. As yet another example, portions of processes 200 and/or 220 can be combined and/or omitted as applicable. For example, instead of generating a pool of fifty key pairs (224), assigning reference values to the pool as a batch operation (226) and storing the keys/values as a batch operation (228), fifty iterations of a process that generates a key pair, assigns a reference value, and stores the information can be performed.

FIG. 2C illustrates another example of the user registration process. In some embodiments, process 230 is performed by device 106. Process 230 can also be performed by other devices, including devices in environments other than those shown in FIG. 1. Process 230 begins at 232 when an initialization value is received. As one example, an initialization value of 50 (corresponding to a target minimum server key cache size of fifty public keys to be stored on platform 102) is received at 232. In some embodiments, in response to receiving a request from a device, such as device 106, platform 102 sets a server count (C)=0. The server count represents the number of public keys currently stored on platform 102 associated with the device. As device 106 is registering, no keys are present yet on platform 102.

In block 234, a number of keypairs may be generated. In this example, a number of asymmetric keypairs equal to the initialization value received at block 232 (e.g., fifty) is generated. In some embodiments, the keypairs are randomly seeded.

In block 236, reference values that are used to uniquely identify each of the key pairs and described in more detail above are assigned for each of the keypairs generated at block 234.

In block 238, the private key portion of the key pairs (i.e., the fifty private keys) and associated reference values are securely stored locally (e.g., on device 106). As one example, the private keys are inserted into a database resident on device 106 and secured using an AES key derived from the password selected by Alice at portion 210 in process 200.

Finally, in block 240, the public key portion of the key pairs (i.e., the fifty public keys) and associated reference values are securely transmitted to platform 102. As mentioned above, platform 102 will designate one of the fifty keys as a reserve key (e.g., by setting a flag associated with that particular key).

### B. Security Platform

As mentioned above, security platform 102 is configured to facilitate the exchange of communications (e.g., among any/all of client devices 106-114). Also as mentioned above, platform 102 can be operated by a variety of entities on behalf of a variety of end users. For example, one embodiment of platform 102 can be made available to members of the public, whether as a public service, or for a fee. As another example, another embodiment of platform 102 can be made available by a business, by a school, by a charitable organization, etc., and its use limited to its employees/students/members, etc., as applicable. Alternatively, platform 102 may be integrated into existing communication platforms implemented by businesses, schools, charitable organizations, etc. Additional detail regarding various aspects of embodiments of platform 102 will now be provided.

Security platform 102 includes one or more interface(s) 118 for communicating with client devices, such as client devices 106-114. As one example, platform 102 provides an application programming interface (API) configured to communicate with apps installed on client devices, such as app 116 and app 138. Platform 102 can also provide other types of interfaces, such as a web interface, or stand alone software programs for desktops and laptops, running on various Operating Systems (OSes). The web interface can allow users of client devices such as client devices 108 and 110 to exchange messages securely (whether with one another or other users), without the need for a separately installed messaging application. The stand alone software program allows users to exchange secure messages via software that is downloaded by each user. As will be discussed in more detail below (e.g., in Section G), in various embodiments, platform 102 makes available (e.g., via one or more interface(s) 118) a master clock time. The master clock time can be used, in various embodiments, to enforce secure time-to-live (TTL) values of messages. The TTL values can be used to enforce (e.g., on behalf of a message sender) time constraints on message access (e.g., by a recipient).

Security platform 102 also includes a database 120. Included in database 120 is a record for each user of platform 102. Each record has associated with it information such as the user's public key pool and associated reference values, deviceID(s), appID(s), and messages. As shown in FIG. 1A, database 120 is relational and stores information in a variety of tables, including a table of hashed usernames (124), a table of public keys and reference values (126), a table of deviceIDs (128), a table of appIDs (130), and a table of messages (132). Other techniques can also be used to store the information used by platform 102. For example, messages can be stored in a separate memory 136 instead of being stored within database 120.

Finally, security platform 102 includes a processing engine 134 which performs a variety of tasks, including interacting with database 120 on behalf of interface(s) 118. As will be described in more detail below, one task performed by platform 102 (e.g., by processing engine 134) is to designate one of the keys in the pool of public keys (e.g., received from Alice at the conclusion of portion 214 of process 200) as a “reserve” key. Another task performed by platform 102 (e.g., processing engine 134) is to facilitate the addition of new keys to a user's key pool as the keys are used. Yet another task performed by platform 102 (e.g., processing engine 134) is to dynamically adjust the size of a user's key pool as needed.

The embodiment of platform 102 depicted in FIG. 1A comprises standard commercially available server hardware (e.g., having a multi-core processor(s), 8 G+ of RAM, gigabit network interface adaptor(s), and hard drive(s)) running a typical server-class operating system (e.g., Linux). In various embodiments, platform 102 is implemented across a scalable infrastructure comprising multiple such servers, solid state drives, and/or other applicable high-performance hardware.

In alternative embodiments, the platform 102 may be a module that integrates into an existing communication tool. FIG. 1B illustrates a communication server 170 that includes a processing engine 134, a memory 136, a user directory 160, and security platform 102. In this regard, the interface(s) 118 described above may communication with existing communication platforms to provide the functionality described herein.

In this regard, the communications server 170 may include a communication platform, such as instant messaging or email. Additionally, the communication server 170 may be a server that executes a productivity tool, such as Microsoft Office or Lotus Notes. According to some embodiments, the communication server 170 may be a stand-alone server, a corporate server, or a server located in a server farm or cloud-computing environment. In some embodiments, the enterprise server 170 may be a virtual machine.

Processing engine 134 may be any conventional processor capable of interacting memory 136, user directory 160, and security platform 102. In this regard, processing engine 102 may include a processor, multiprocessor, multicore processor, or any combination thereof. Alternatively, the processor may be a dedicated controller such as an Application Specific Integrated Circuit (ASIC) or Field Programmable Gate Array (FPGA).

Memory 136 stores information accessible by processing engine 134, including instructions and data that may be executed or otherwise used by the processing engine 134. The memory 136 may be of any type capable of storing information accessible by the processing engine, including a non-transitory computer-readable medium, or other medium that stores data that may be read with the aid of an electronic device, such as a hard-drive, solid state drive, memory card, flash drive, ROM, RAM, DVD or other optical disks, as well as other write-capable and read-only memories. Memory 136 may include short term or temporary storage as well as long term or persistent storage. According to some embodiments, memory 136 may include a storage area network (SAN) accessible by the communication server 170.

User directory 160 may be any database or table capable of providing directory services. For example, user directory 160 may include a corporate directory that include users first and last names, their usernames, email address, phone numbers, department information, etc. Additionally, the user directory 160 may be used to share information about users, systems, networks, services and applications. According to some embodiments, the user directory 160 may include a Lightweight Directory Access Protocol (LDAP). In some embodiments, user directory 160 may also include a table of hashed usernames, a table of appIDs, and a table of deviceIDs.

The security platform 102 may be a module that is integrated into the communications server 170 and performs the functionality described herein. In this regard, the module may be software that interacts with the existing communication tools via APIs. Alternatively, the module may be hardware or a special-purpose computer incorporated into the communication server 170 to add the functionality described herein to the communication server.

Whenever platform 102 is described as performing a task, either a single component or a subset of components or all components of platform 102 may cooperate to perform the task. Similarly, whenever a component of platform 102 is described as performing a task, a subcomponent may perform the task and/or the component may perform the task in conjunction with other components.

### C. Sending DSB Secured Messages

Returning back to Alice's desire to send a message to Bob: at the conclusion of Section A above, Alice has successfully registered her username (“Alice”) with security platform 102. And, Bob is also a user of platform 102. Suppose Alice would like to send a message to Bob. She starts app 116 and is presented with an interface that includes a “compose” option. Alice selects the compose option and is presented with a message composition interface.

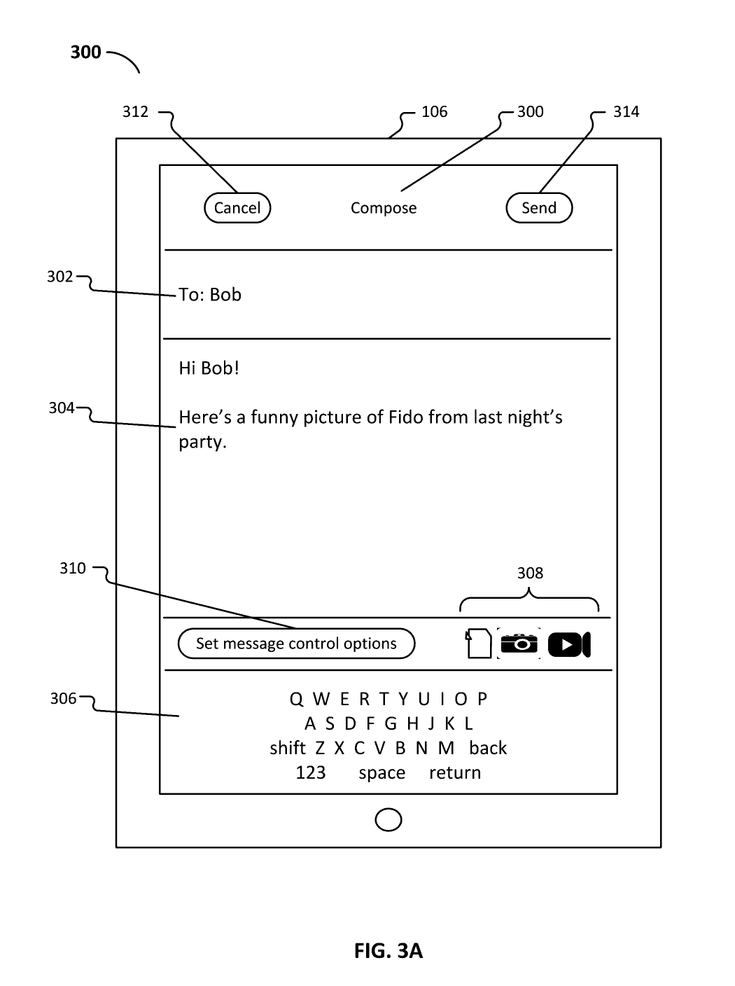

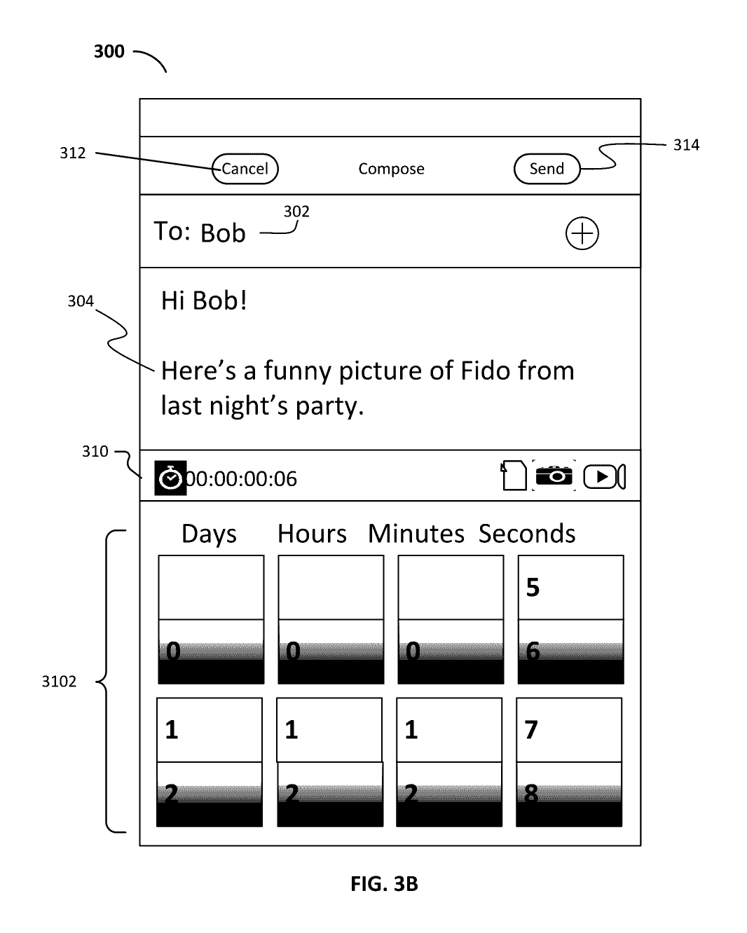

An example message composition interface is shown in FIGS. 3A and 3B. In particular, FIG. 3A depicts interface 300 as rendered on an example tablet device 106, connected to the Internet via an appropriate connection, such as: 3G, 4G or higher cellular connection, WiFi, satellite, wireless or wired LANs, Bluetooth, etc. Tablet device 106 includes a touchscreen. An on-screen keyboard is provided for Alice in region 306. Alice can enter the usernames of one or more recipients in region 302. She can enter message text in region 304. Alice can optionally add attachments by interacting with buttons shown in region 308. Examples of attachments include, but are not limited to: documents, pictures, and audiovisual clips. By selecting button 310, Alice can specify various message control options, such as: the lifetime/expiration of the message (the enforcement of which is described in more detail below in Section G); on which device(s) it can be unencrypted/read; and sharing, saving, forwarding, recalling, and deleting options.

By selecting button 310, Alice may be provided message control options that specify how recipients handle the received message. In particle, Alice may set a time-to-live (TTL) option for the message by selecting button 310. FIG. 3B illustrates an example of a message composition interface for setting message control options.

Specifically, FIG. 3B shows an example of setting a TTL option. Similar to FIG. 3A, FIG. 3B depicts interface 300 as rendered on Alice's device 106. In the following example, Alice is composing a message to Bob. In region 302, Alice has addressed the message to Bob. Region 304 illustrates the message that Alice has typed up for Bob. After composing the message, Alice may select button 310 in FIG. 3A. Accordingly, she will be presented with the interface depicted in FIG. 3B. In this regard, Alice may select the amount of time for which, once Bob open's Alice's message, Bob will be able to view the message in region 3102. As shown in region 310, Alice has decided to allow Bob to read the message for six seconds once he opens it. When Alice sends the message (by selecting button 314), a time value of six seconds (an example of a TTL) will be included as a message control option.

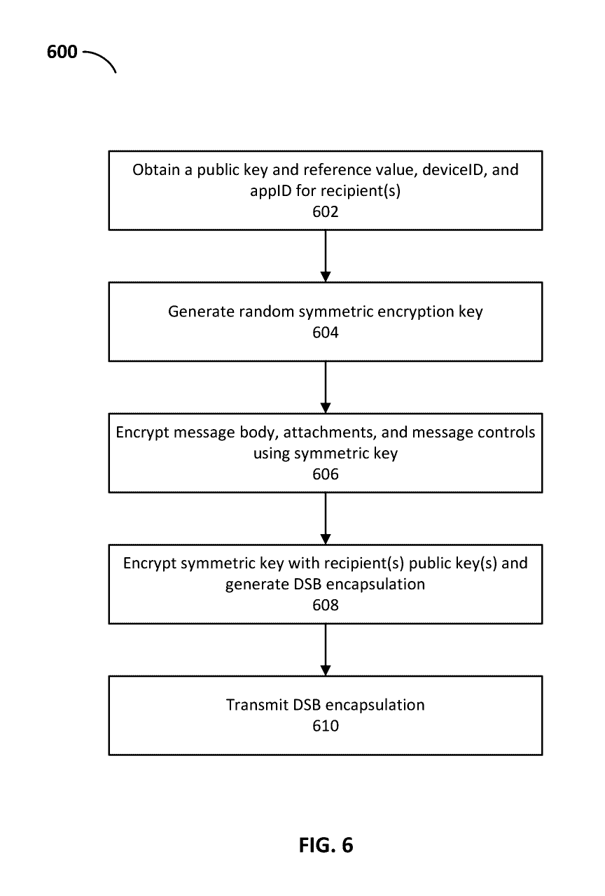

If Alice is satisfied with her message, she can send it to Bob by clicking the send button (314). If she wishes to cancel out of composing the message, she can click the cancel button (312). Suppose Alice clicks send button (314) after composing the message shown in interface 300. An example of the events that occur, in some embodiments, in conjunction with sending a message is illustrated as process 600 in FIG. 6.

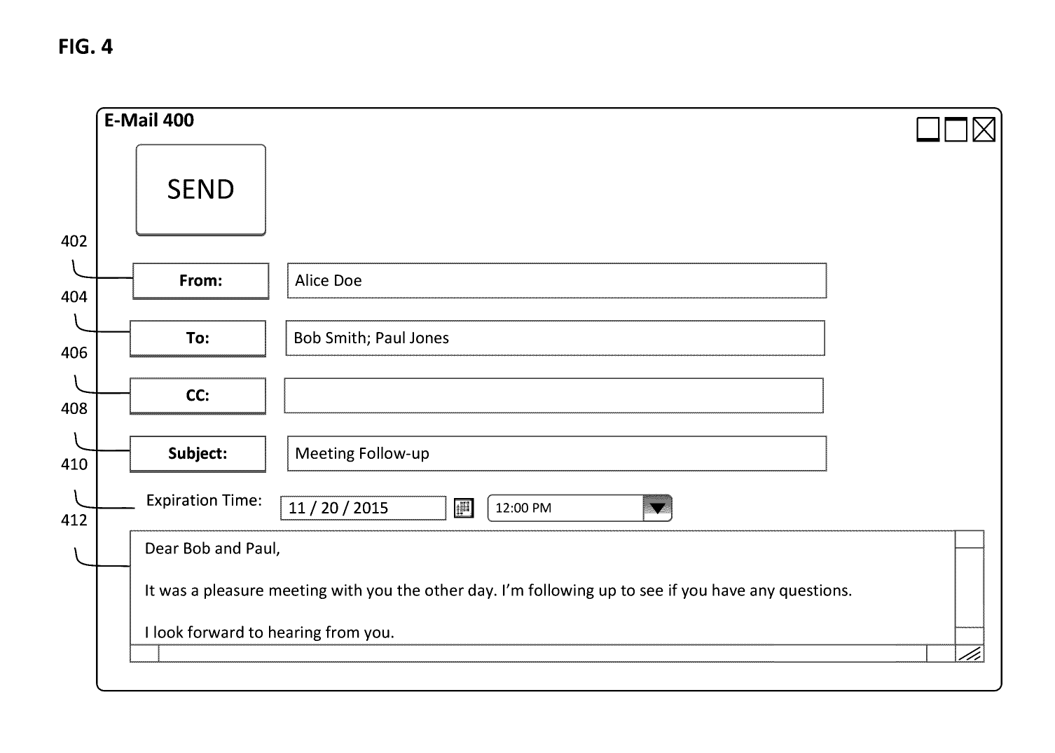

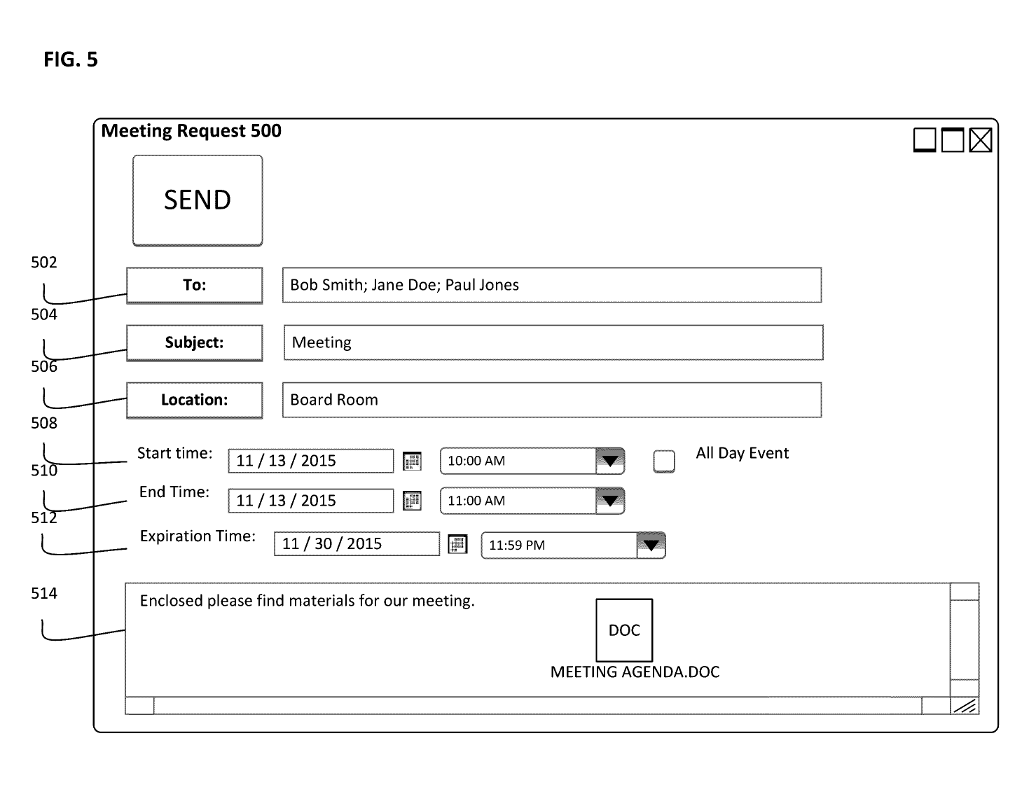

According to embodiments where the security platform is incorporated in existing communications tools, Alice may be permitted to send encrypted e-mails and meeting requests with message control options, such as a TTL option. FIGS. 4 and 5 illustrate examples of composing an e-mail and a meeting request, respectively.

Turning to FIG. 4, an e-mail composition interface is shown. In this regard, the email 400 includes a From Field 402, a To Field 404, a CC Field 406, a Subject Field 408, an Expiration Time Field 410, and a Body Field 412. The From Field 402, To Field 404, CC Field 406, Subject Field 408, and Body Field 412 are all common to e-mail composition. The Expiration Time 410 allows a sender to set an expiration time for e-mail 400. In alternative embodiments, an administrator may set the expiration time to a default. For example, in the financial industry, an administrator may set the expiration time to 7 years in order to comply with financial regulations. At the conclusion of the expiration time, the e-mail 400 will be made inaccessible to the receiver. In this regard, inaccessible may include expiring the key required to decrypt the message or deleting the message. Once the e-mail is complete, the sender can send the e-mail by hitting the send button.

A meeting request 500 is illustrated in FIG. 5. In this regard, the meeting request 500 includes a To Field 502, a Subject Field 504, a Location Field 506, a Start Time Field 508, an End Time Field 510, an Expiration Time Field 512, and a Body Field 514. Most of the fields are all well-known with respect to meeting requests; the exception being the expiration time field 512. In this regard, the Expiration Time field 512 may permit a meeting organizer to set an expiration time or a TTL for the meeting 500. Alternatively, the Expiration Time 512 may be set by an administrator or other third-party. At the conclusion of the expiration time, the meeting 500 will be inaccessible to the receiver, including any attachments or pre-meeting work included in the meeting request. As noted above, rendering the meeting inaccessible may include expiring the key required to decrypt the meeting or deleting the meeting from the receiver's calendar. Once the meeting request is complete, the sender can send the meeting request by hitting the send button, which will create a calendar invite (i.e., email) with the meeting request as an attachment. In this regard, the calendar invite may have a different time-to-live value than the meeting request.

FIG. 6 illustrates an example of a process for sending a DSB-secured message. In some embodiments, process 600 is performed on a client device, such as Alice's client device 106. The process begins at 602 when a particular public key (from the user's pool of public keys) and associated reference value, deviceID, and appID of a recipient are obtained from platform 102. As will be explained in more detail below, the recipient's particular public key, deviceID and appID are used in the encryption of the symmetric key used to encrypt data, and in the DSB encapsulation of the message for the hardware/appID binding of the message. As one example, app 116 can request the information from platform 102 via an API (e.g., interface 118). In some embodiments, the information is retrieved when Alice enters the recipient's name into the address space (e.g. region 302 in FIG. 3; field 402 in FIG.4; or field 502 in FIG. 5). In other embodiments, the information is retrieved when Alice clicks send button, or at any other appropriate time (e.g., while she is composing a message). In the example shown in FIGS. 4 and 5, Alice is sending the e-mail and meeting request to Bob, as well as other users. Accordingly, one of their respective public keys (again selected from their respective pools of public keys) and associated reference values, deviceIDs, and appIDs for each of the recipients will also be retrieved at block 602.

In block 604, a random symmetric encryption key is generated (e.g., by app 116 on device 106). As one example, the symmetric key is an AES 256 bit key. Next, in block 606, the symmetric encryption key is used to encrypt the message body, any attachments, and any message control options. In some embodiments, Alice's own information (e.g., public key(s) and associated reference value(s), deviceID(s), and appID(s) are included in the DSB as well. In block 608, the symmetric key is encrypted with the particular public key of each recipient (obtained from the pool of public keys) and the DSB encapsulation is generated, which contains the aforementioned components and reference values of the public keys used to encrypt the symmetric key. Examples of the DSB format are provided in Section D below.

In some cases, a user may own multiple devices. For example, Bob may be the owner of device 114 and 112, both of which are configured with secure messaging apps. Each of Bob's installations will have its own deviceID and appID. When the DSB is created, each of Bob's devices will be considered a separate device under the same username account.

Finally, in block 610, the generated DSB is securely transmitted to platform 102 (e.g., by being encrypted with a symmetric key shared by the app and platform 102, and also encapsulated by TLS as an additional security layer). Irrespective of how many recipients Alice designates for her message (and, e.g., how many recipients there are or how many devices Bob has), only one DSB will be created and transmitted to platform 102. Upon receipt of the DSB, processing engine 134 opens the DSB and determines the recipients of the message. Specifically, the processing engine 134 performs a match against the deviceIDs (in a cryptographic hash and camouflaged representation) included in the DSB and the deviceIDs stored in database 120 as well as the username (in a cryptographic hash and camouflaged representation) in the DSB and the ones stored in the database 120. A cryptographic hash and camouflaged representation means that the hash algorithm (i.e. SHA256) that is used for the deviceID, username, and appID values, is further camouflaged, in some embodiments, by taking multiple hashes of the result values (i.e. multiple rounds of SHA256 of the previous SHA256 value—i.e. SHA(SHA(SHA(SHA . . . ))). Processing engine 134 also creates an entry for the received DSB in message table 132 and notifies the recipient(s) that a new message is available. In various embodiments, other actions are also performed by platform 102 with respect to the DSB. As one example, platform 102 can be configured to remove the DSB as soon as the recipient successfully downloads it. As another example, platform 102 can enforce an expiration time (e.g., seven days) by which, if the DSB has not been accessed by the recipient, the DSB is deleted. Where multiple recipients are included in a DSB, platform 102 can be configured to keep track of which recipients have downloaded a copy of the DSB, and remove it once all recipients have successfully downloaded it (or an expiration event has occurred).

### D. DSB Examples

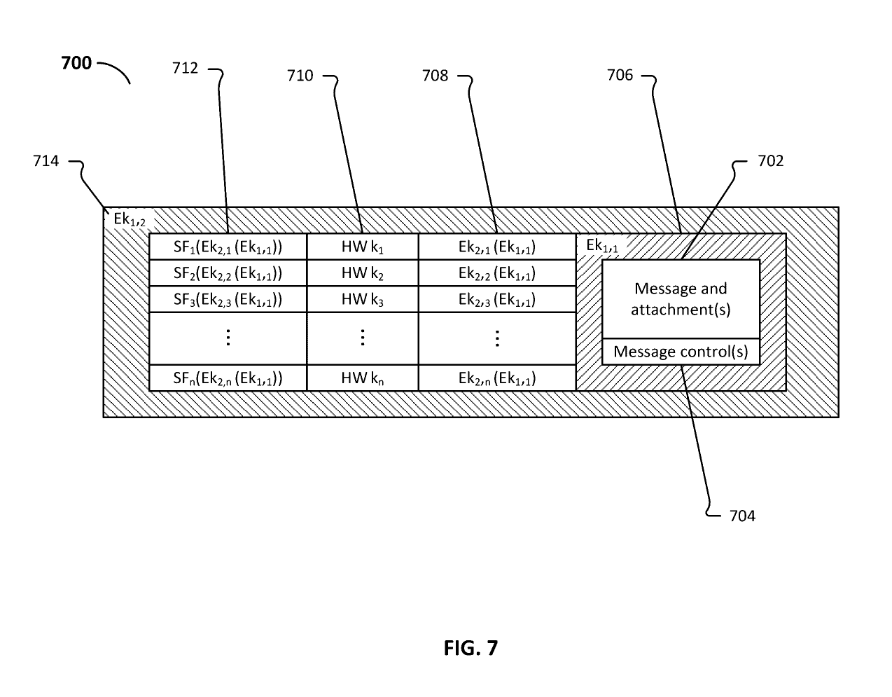

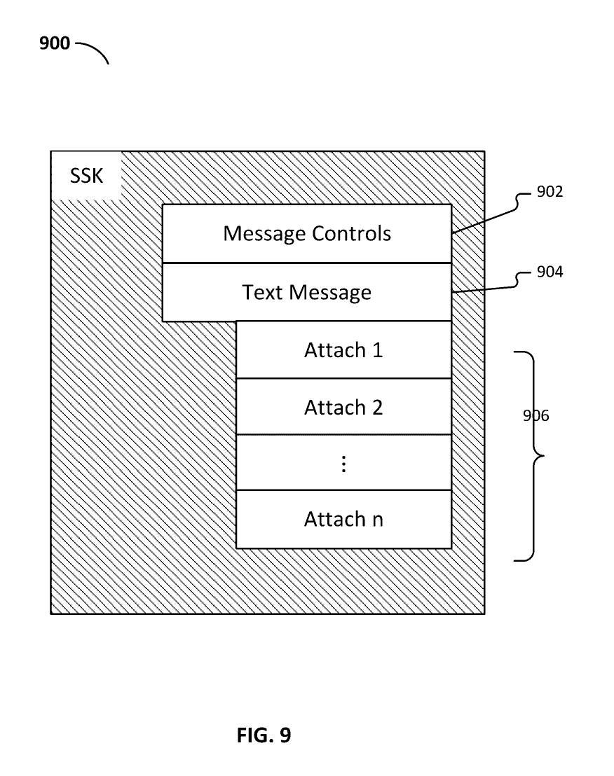

FIG. 7 illustrates an example of a digital security bubble (DSB). DSB 700 is an example of output that can be generated by app 116 as a result of executing process 600. In the example shown, DSB 700 includes a message and optional attachments (702), such as meeting request 500, and one or more message controls (704) encrypted with a key Ek_{1,1} (encrypted portion 706). In some embodiments, key Ek_{1,1} is generated by app 116 at block 604 of process 600. Additional detail regarding portion 706 is shown in FIG. 9, where SSK in FIG. 9 is Ek_{1,1} of FIG. 7 and represents the sender's symmetric shared key used to encrypt the message and attachments.

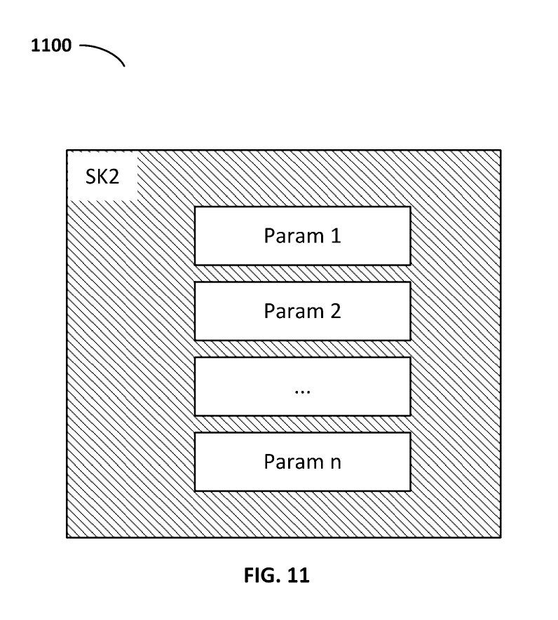

DSB 700 also includes, for each message recipient 1-n, the key Ek_{1,1} encrypted by each of the recipient's respective particular public keys (as shown in region 708). Further, DSB 700 includes a combination of each recipient's respective deviceID, hashed username, appID, and the reference value associated with the particular public key (collectively denoted HWk₁₋ₙ) in region 710. These constituent parts are also referred to herein as “parameters.” Additional detail regarding the parameters is shown in FIG. 11—namely, a plurality of parameters (such as hashed username, deviceID, and appID) are encrypted using SK2, which is a symmetric key generated by the client and shared with platform 102.

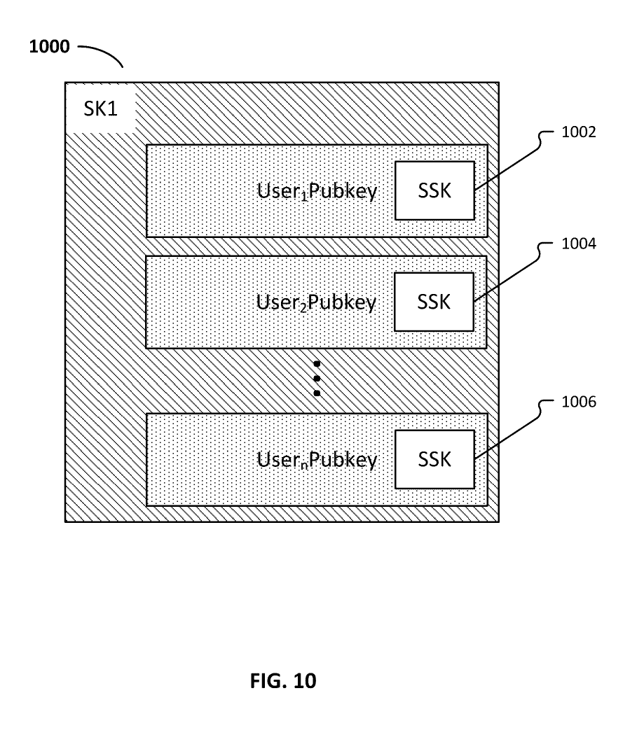

In some embodiments (e.g., as is shown in FIG. 7), a spreading function is used to spread the encrypted symmetric keys inside the DSB (as shown in region 712), by spreading the bits of the encrypted key in a spreading function generated pattern, with the default function being a sequential block or data. The spreading function also contains the cryptographic hashed representation of the recipient usernames that are used by the server to identify the recipients of the message and to set the message waiting flag for each of them. Finally, the DSB is itself encrypted using key Ek_{1,2} (encrypted portion 714), which is a symmetric key shared between app 116 and platform 102. Additional detail regarding portions 714 and 708 are shown in FIG. 10, where SK1 in FIG. 10 is Ek_{1,2} in FIG. 7 and represents the symmetric encryption key shared by the app and platform 102, and where User₁Pubkey in FIG. 10 is Ek_{2,1} in FIG. 7 and represents the recipient's particular public key (e.g., selected from the pool of public keys generated at 202).

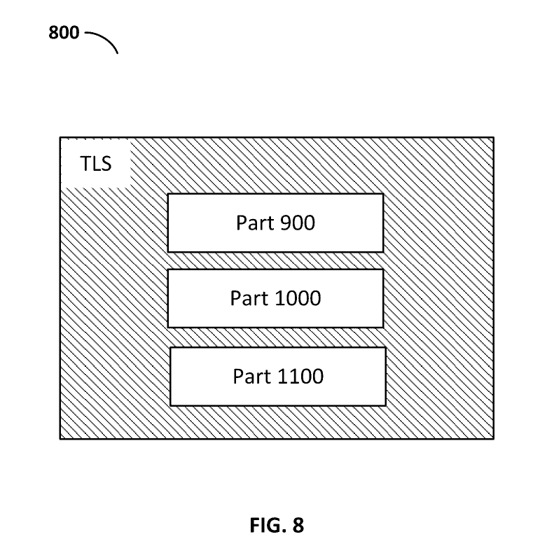

FIGS. 8-11 illustrate additional examples of the construction of an embodiment of a DSB. FIG. 8 illustrates an example of a DSB 800. DSB 800 encapsulates three subcomponents—part 900 (the encrypted message, attachments, and message controls), part 1000 (the symmetric key encrypted with each recipient's particular public key selected from the recipients' respective key pools), and part 1100 (encrypted message parameters). As with DSB 700, a symmetric key (shared by app 116 and platform 102) is used to secure the DSB. In addition, the transmission of the DSB to the server is encapsulated with TLS for an additional security layer. FIG. 9 illustrates part 900 of DSB 800. In particular, part 900 includes the message controls (902), message (904), and attachments (906). Part 900 is encrypted using a shared symmetric key SSK (e.g., Ek_{1,1}). FIG. 10 illustrates part 1000 of DSB 800. In particular, part 1000 includes the shared symmetric key, encrypted to each of the recipients' respective particular public keys (selected from the recipients' respective key pools). Further, the collection of encrypted keys (1002-1006) is encrypted using symmetric key SK1. FIG. 11 illustrates part 1100 of DSB 800. In particular, part 1100 includes encrypted message parameters. Part 1100 is encrypted using symmetric key SK2.

### E. Receiving DSB Secured Messages

As mentioned above, Bob is also a user of platform 102. When Bob loads his copy of the messaging app on his smartphone (i.e., app 138 on device 114), the app communicates with platform 102 (e.g., via interface 118) to determine whether Bob has any new messages. As will be described in more detail below, platform 102 will also determine how many additional keypairs Bob's device should generate to replenish his pool, and facilitate the generation of those keypairs. Since Alice has sent a message to Bob since he last used app 138, a flag is set in database 120, indicating to app 138 that one or messages are available for download.

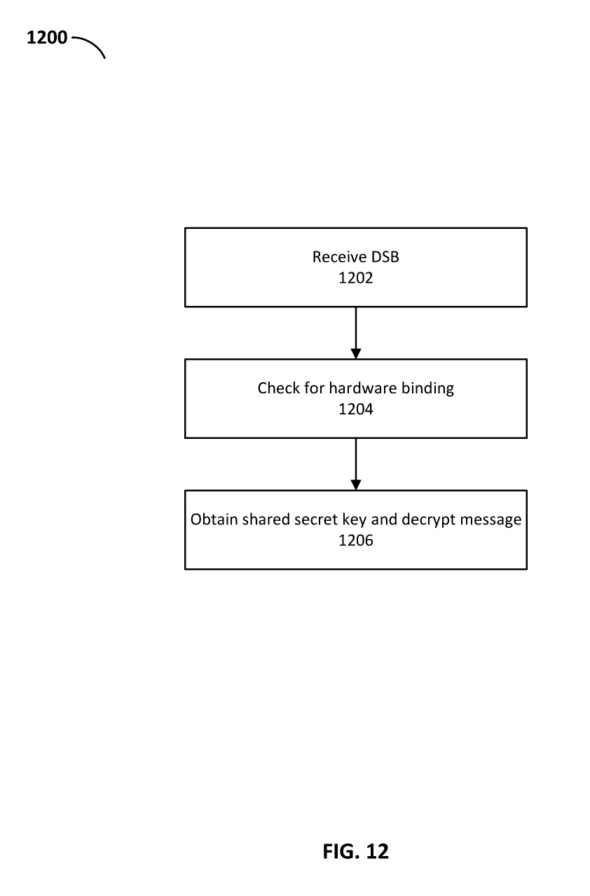

FIG. 12 illustrates an example of a process for accessing a message included inside a digital security bubble. In some embodiments, process 1200 is performed on a client device, such as Bob's client device 114. The process begins at block 1202 when a DSB is received. As one example, a DSB is received at 1202 when app 138 contacts platform 102, determines a flag associated with Bob's account has been set (e.g., indicating he has one or more new messages), and downloads the DSB from platform 102. In such circumstances, upon receipt of the DSB, client 114 is configured to decrypt the DSB using the particular private key of Bob that corresponds to the public key that was selected from his pool at message creation time (and is identifiable by the reference value included in the DSB).

At block 1204 (i.e., assuming the decryption was successful), hardware binding parameters are checked. As one example, a determination is made as to whether device information (i.e., collected from device 114) can be used to construct an identical hash to the one included in the received DSB. If the hardware binding parameters fail the check (i.e., an attempt is being made to access Alice's message using Bob's keys on a device that is not Bob's), contents of the DSB will be inaccessible, preventing the decryption of Alice's message. If the hardware binding parameter check is successful, the device is authorized to decrypt the symmetric key (i.e., using Bob's private key generated at 202) which can in turn be used to decrypt Alice's message (1206). As will be described in more detail below (e.g., in Section G), additional controls can be applied (e.g., by Bob's app 138) to Bob's ability to access Alice's message.

### F. Additional Example Processes

The following are examples of processes that can be performed by various entities present in environment 100, such as platform 102 and devices 106 and 114 in various embodiments (whether as alternate versions of or additional processes to those described above). The processes can also be performed outside of environment 100, e.g., by other types of platforms and/or devices.

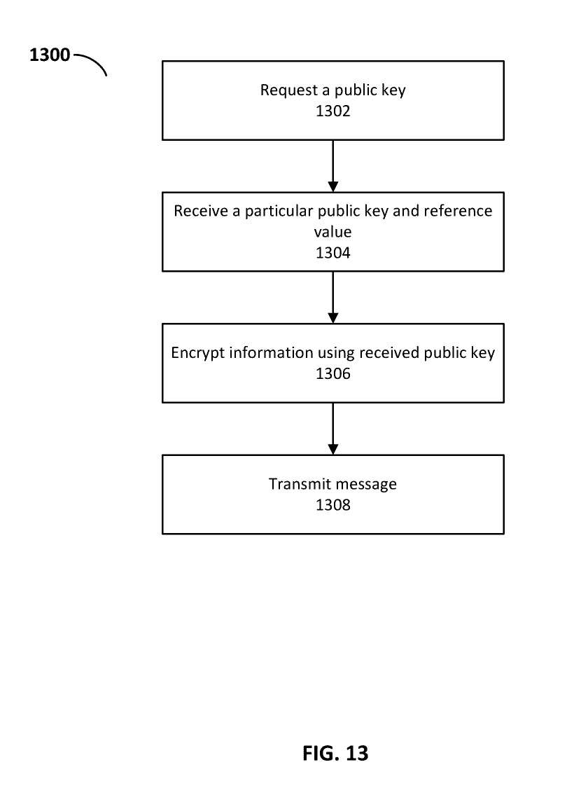

FIG. 13 illustrates an example of a process for sending a message. In some embodiments, process 1300 is performed by device 114 (e.g., when Bob wants to send a message to Alice). Process 1300 begins at block 1302 when device 114 requests a public key associated with Alice from platform 102. If multiple public keys for Alice are present in her pool of keys (i.e., the pool of public keys stored on platform 102 for Alice), the platform will preferentially select (whether randomly, sequentially, or by any other appropriate selection technique) one of the non-reserve keys, and delete the selected key in an atomic operation in conjunction with sending the selected key to device 114. As will be described in more detail below, if only one public key is present for Alice (i.e., only the reserve key remains in the pool), platform 102 will send the reserve key to device 114, but will not delete the reserve key from platform 102 (until such time as the reserve key is replaced with a new key designated as the reserve).

In block 1304, a public key is received (e.g., by device 114 from platform 102) along with the reference value associated with the key. Next, at block 1306, the received public key is used to encrypt information, such as a message, or other information (e.g., a symmetric key which in turn is used to encrypt the message). The key reference value associated with the received public key is included in the message metadata or otherwise incorporated into the message payload.

Finally, at block 1308, device 114 sends the message (e.g., to platform 102 for retrieval by Alice). Note that using techniques described, Alice's device(s) need not be online (e.g., connected to platform 102) at the time Bob composes and/or sends messages to her.

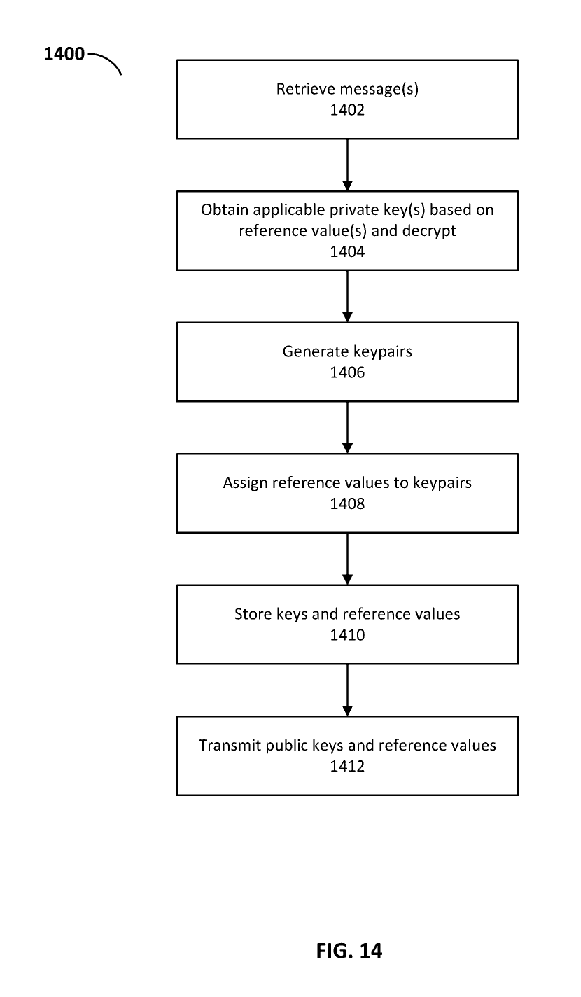

FIG. 14 illustrates an example of a process for performing a synchronous key cache update. In some embodiments, process 1400 is performed by device 106 (e.g., when Alice connects to platform 102 to retrieve messages). The process begins at block 1402 when device 106 connects to platform 102 and retrieves one or more messages.

For each retrieved message at block 1402, the device 106 will read the respective key reference value (e.g., included in the respective message as metadata), retrieve the appropriate private key (i.e., having the key reference value) from local storage on device 106, and decrypt the message(s) in block 1404.

Next, at block 1406, device 106 generates additional keypairs (i.e., to replenish public keys used from the pool on platform 102 by Bob). The number of keys to be generated can be determined in a variety of ways. As one example, device 106 can generate a number of new keypairs equal to the number of messages she received at 1402. As another example, device 106 can be instructed (whether by platform 102 or local instructions) to generate the lesser of: A: (the number of messages downloaded at 1402*V), where (V) is a variable impacting the desired expansion rate of the server cache size (e.g. 0.9); or B: the initialization value (e.g., 50 keys).

At block 1408, reference values (e.g., usable to uniquely identify each of the key pairs and described in more detail above) are assigned for each of the keypairs generated at 1406. In block 1310, the private key portion of the key pairs (i.e., the new private keys) and associated reference values are securely stored locally (e.g., on device 106). As one example, the private keys are inserted into a database resident on device 106 and secured using the password selected by Alice at 210 in process 200.

Finally, at block 1412, the public key portion of the key pairs (i.e., the new public keys) and associated reference values are securely transmitted to platform 102. In this example, suppose Alice's reserve key was not depleted. The key originally designated as her reserve key remains present on platform 102 and remains designated as the reserve key. Now suppose Alice's reserve key was depleted (e.g., because Bob and/or other users of platform 102 sent Alice more than fifty messages prior to her connecting to platform 102). The first 49 messages addressed to Alice would make use of those public keys in her pool not designated as the reserve key. Any additional messages sent to Alice before she can replenish her pool will all make use of her reserve public key (i.e., messages 50, 51, and 52—whether from Bob or others, will all make use of the same public key for Alice—her reserve key). As will be explained below, when Alice's pool has been deleted (i.e., her reserve key is being used), a flag will be set on platform 102 indicating that, in conjunction with her next execution of process 1400 (or portions thereof, as applicable), a new key should be designated as the reserve key, and the existing reserve key be destroyed. Additional actions can also be taken (e.g., by platform 102) in response to Alice depleting her key pool, such as by increasing the size of her pool.

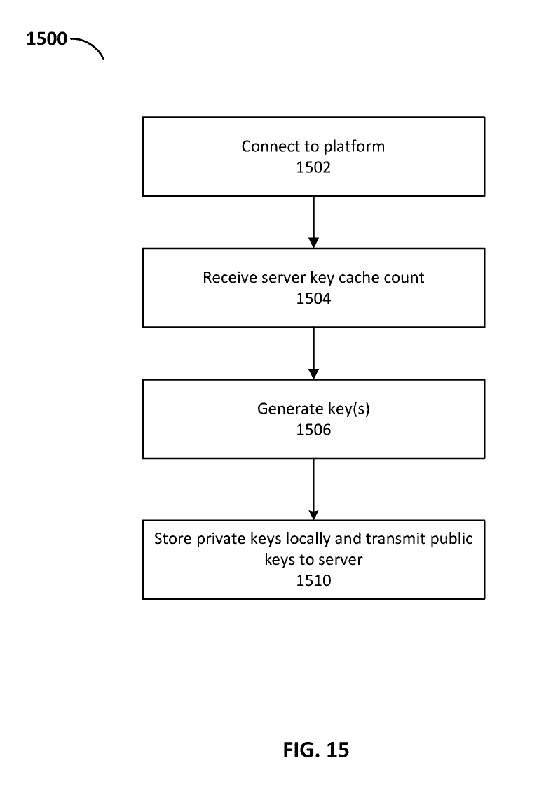

FIG. 15 illustrates an example of a process for performing an asynchronous key cache update. In some embodiments process 1500 is performed by device 106. Process 1500 begins when device 106 connects to platform 102 in block 1502. The connection can be periodic (e.g., app 116 can be configured to connect to platform 102 once a day, once an hour, etc.) and can also be in response to triggering events (e.g., Alice's phone was powered off and has just been powered on, has just connected to a cellular or other network, etc.).

In block 1504, the device receives the current server key cache count (i.e., the number of keys presently in the platform's pool for the user). At block 1506, the device generates an appropriate number of keypairs (and reference values) and stores/transmits them in accordance with the techniques described above in block 1510. Further, in the event the server key cache count is zero (i.e., the reserve key is being used by platform 102 due to key pool depletion), one of the newly generated keys will be designated by the server as a replacement reserve key and the old reserve key will be destroyed.

### G. Secure Time-to-Live (TTL)

As mentioned above, one example of a message control a sender can specify for a message is a limit on the time period (also referred to herein as a “time-to-live” or “TTL”) during which a recipient is able to access the message (e.g., to view, listen to, or otherwise interact with the message and any attachments). In scenarios such as where the sender is using an embodiment of platform 102 operated by an enterprise on behalf of its employees, the TTL may be selected by an entity other than the sender (e.g., based on a default corporate policy, or based on administrator configurable rules implemented by an enterprise-specific version of the secure messaging application). For example, messages sent by employees to one another can have a first default TTL, and messages sent by employees to vendors (also using the enterprise-specific application) can have a second default TTL. As another example, messages sent by certain employees (e.g., within a particular department such as the legal department, or having certain titles or positions) can be given different default TTLs. In various embodiments, the default TTL can be overridden, if permitted by an administrator configuration.

The TTL is encrypted and sent together with the secure message. When the recipient opens the message (e.g., taps or clicks on the message in an app), the message is decrypted and displayed on the recipient's device. The corresponding TTL is decrypted, and in some embodiments converted into a message expiry time by adding the TTL (e.g., expressed in seconds) to the current time. In various embodiments, the TTL is stored in the recipient's device's secure database and encrypted to prevent tampering with the secure TTL by the device's user. As will be described in more detail below, the current time can also be secured (e.g., against attempts by the recipient to thwart the TTL by adjusting a clock on the recipient's device). Once the TTL has expired, the message is no longer accessible to the recipient (e.g., is removed from the recipient's viewing interface and deleted from the recipient's device's secure database, along with any associated decryption keys).

The sender (or sender's application, as applicable, e.g., where configured by an enterprise administrator) can specify time limits in a variety of ways. As one example, the sender can set a maximum duration (e.g., a one day limit), with the time limit countdown commencing when the recipient first opens the message. The time limit countdown can also be commenced when the sender sends the message. As another example, the sender can specify a fixed start time (e.g., for embargo purposes) before which the recipient is unable to access the message, even if the recipient is already in possession of the message. Once the embargo period ends, as with above, a TTL value can control how long the recipient is able to view the message once opened. This allows, for example, a company to release company news to multiple shareholders in a secure, time-controlled manner, with each shareholder having the same opportunity to open the message at the same start time. This also allows an enterprise to implement rules (e.g., via an enterprise-specific version of the secure messaging application/platform 102) that only allow employees to open messages during certain periods of the day. (E.g., hourly workers can only read messages during business hours; salaried workers have no such prohibition.) As yet another example, the sender can specify a fixed end time after which the recipient is unable to access the message (irrespective of whether the message was also given an “upon opening” TTL, e.g., of ten minutes). Further, in various embodiments, a sender of the message can shorten a limit on an already sent message. For example, if Bob sends Alice a message with a one day limit, and Alice opens that message, Bob can subsequently revoke Alice's ability to continue to read the message (even though the day has not passed) by interacting with his app (e.g., by long pressing on the sent message as it appears to Bob and selecting an “expire now” (immediately expiring the message) or “expire faster” (expiring the message at a new time picked by Bob) option, as applicable).

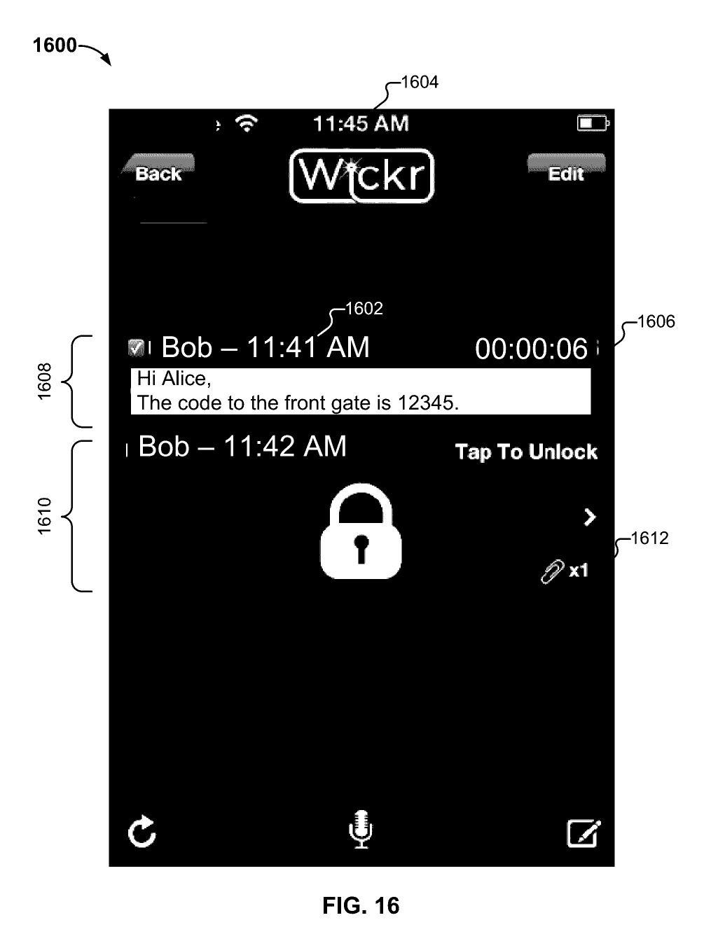

FIG. 16 illustrates an embodiment of a message viewing interface. In particular, FIG. 16 depicts interface 1600 as rendered on Bob's device 114. In the example of FIG. 16, Bob has just opened the message Alice was composing in interface 300 of FIGS. 3A and 3B. As indicated in region 1302, Alice sent the message to Bob at 11:41 am. As indicated in region 1604, Bob's device has a time of 11:45 am. As indicated in region 1606, Bob has six seconds to read message 1608. After the six seconds have elapsed, message 1608 will be removed from interface 1600 (and deleted from Bob's device). Also shown in interface 1600 is a message from Alice that Bob has not yet opened (1610). Alice sent message 1610 at 11:42 am, and message 1610 includes one attachment, as indicated in region 1612. Since Bob has not yet opened message 1610, the TTL for message 1610 has not yet been applied to the message. Bob can open message 1610 by clicking on it with her finger. In the event Bob has multiple devices, in some embodiments a received but unopened message (e.g., message 1610) will appear on all of Bob's devices rendered in the manner shown in FIG. 16. In some embodiments, once Bob opens the message on one of the devices, he will be unable to open the message on any of his other devices (i.e., any additional copies of message 1610 will be removed, unopened, from Bob's other devices). In other embodiments, Bob's messages are synchronized across all of her devices, and Alice is allowed to read any of her messages which have not yet expired on any of those devices. In this scenario, the remaining TTL for a given message can be calculated using the time the message is initially opened on a first device/file, and the remaining TTLs reported by all devices on which the message has been opened. For example, suppose Alice sends a message to Bob and sets the TTL to ten minutes. If Bob has three different devices associated with his account (e.g., an iPhone, an Android tablet, and a desktop computer), he is allowed to open the message on any (or all) of his devices as long as the TTL that Alice established (ten minutes in this example) is not exceeded, collectively, across Bob's devices. Suppose Bob opens the message first on his iPhone (e.g., at 11 am) and views it for three minutes. The TTL for the message at that moment is 10−3=7 minutes. If, after two more minutes (e.g., at 11:05 am) Bob opens the same message on his desktop computer, the TTL is now 7−2=5 min. After five more minutes have elapsed (e.g., it is now 11:10 am), if he tries to open the message again on his iPhone, or on his Android tablet, the TTL will be zero, and the message will be deleted from all of Bob's devices. One way of synchronizing the TTL in a multi-device scenario (also referred to herein as the “global TTL” for the message) is for each app to report the remaining TTL for a particular message ID each time the message is opened on that device. The global TTL for that message ID can be synchronized between all of Bob's devices via a variety of mechanisms. For example, Bob's devices could be configured to update one another on the remaining TTL. As another example, platform 102 can receive updates (i.e., reported openings/TTLs) from each of Bob's devices and share that information with other of Bob's devices with the remaining TTL.

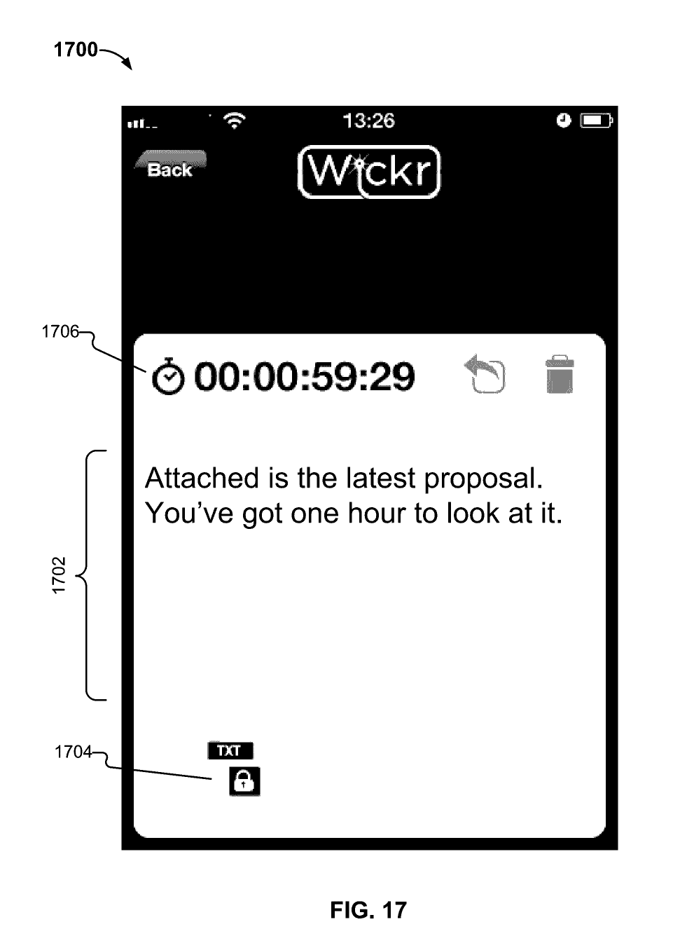

FIG. 17 illustrates an embodiment of a message viewing interface. In particular, FIG. 17 depicts interface 1700 as rendered on Alice's tablet 106. In the example of FIG. 17, Alice (at 1:26 pm) has just opened the message that Bob sent her at 11:42 am. In region 1702, Alice is viewing text authored by Bob. Alice can review an attachment that Bob sent by clicking on region 1704. Region 1706 includes a countdown timer that indicates to Alice that she has approximately one hour (59 minutes and 29 seconds) remaining to read Bob's message and view the attachment. When the timer reaches zero, Alice will be unable to view the message or attachment further.

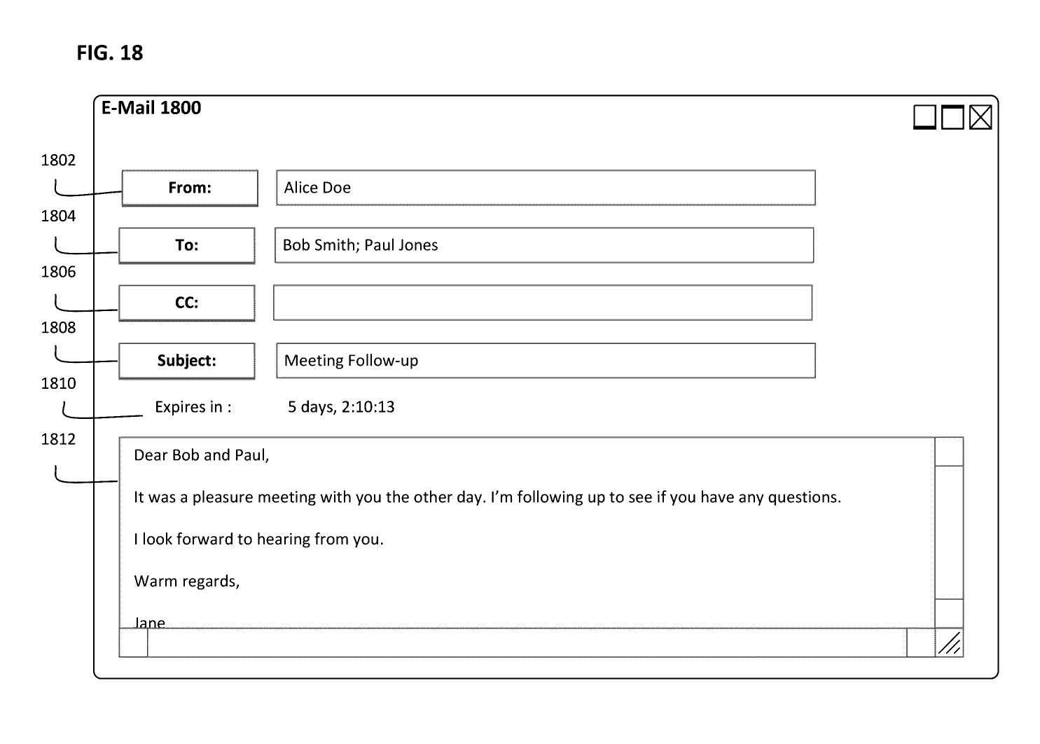

FIG. 18 shows an example of a e-mail received with an expiration timer. That is, FIG. 18 depicts a received email 1800 as it would be displayed in a communication tool, such as Microsoft Outlook or Lotus Notes. The received email includes a From Field 1802, a To Field 1804, a CC Field 1806, a Subject Field 1808, Expiration Field 1810, and a body 1812. In the example depicted in FIG. 1800, the email 1800 is from “Alice Doe” and is addressed to “Bob Smith” and “Paul Jones.” Accordingly, Bob and Paul's e-mail client would decrypt the received DSB as described above to view the enclosed email. When email 1800 is opened, the expiration timer 1810 will begin counting down and display the time remaining that the recipients can view the email 1800. In this regard, the timer may begin counting down when Bob opens the email. Accordingly, Bob's device will notify the communication server 170 depicted in FIG. 1B, which will manage the expiration time for both Bob and Paul's devices. Thus, if the timer expires before Paul has an opportunity to view the message, Paul may be denied access to e-mail 1800.

Alternatively, the expiration time may be independent for each recipient. Thus, the expiration field 1810 may reflect different times for each recipient. In some embodiments, the expiration time may be set to a specific date and time. According to these embodiments, the expiration field 1810 may show the date and time that e-mail 1800 expires instead of a countdown.

In some embodiments, the recipient may be an external user that does not have the security platform. The communication server 170 may not send the email to the recipient, and instead send a notification, for example via email or text message, to the recipient that includes a link to the email. In this regard, the recipient will access the email through a secure web interface hosted by the communication server 170. Accordingly, the secure communication server 170 may control access to the message and enforce the TTL value associated therewith.

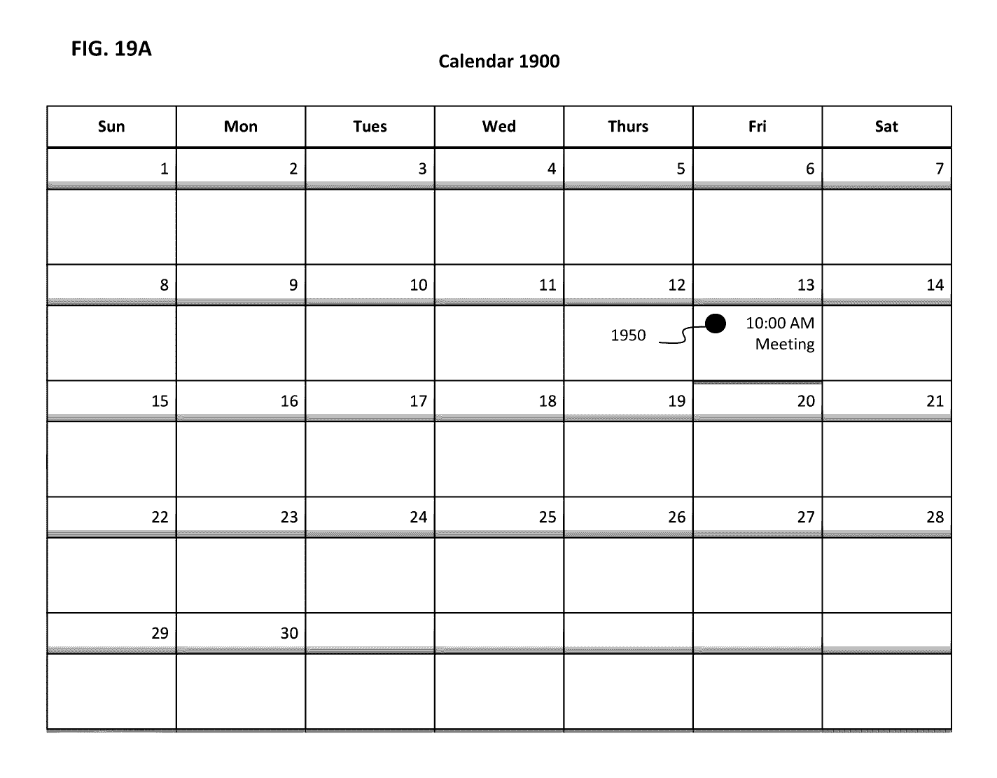

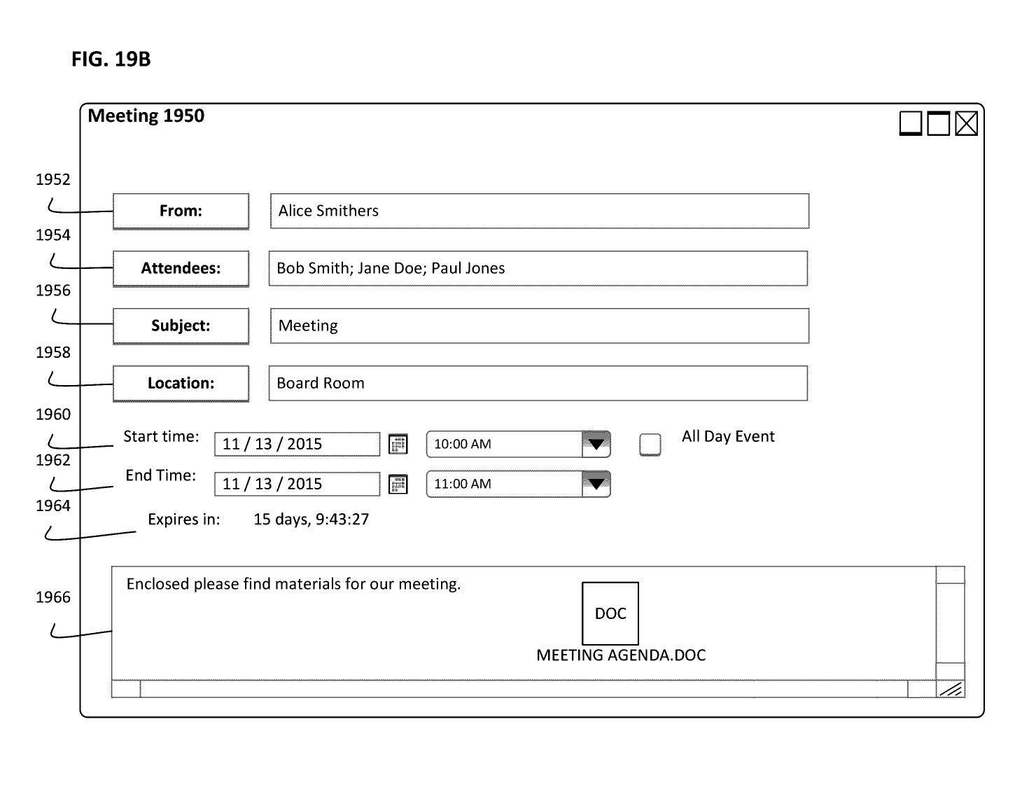

FIG. 19A illustrates an example of calendar 1900. As discussed above, the calendar 1900 may be included in an app downloaded from a software distribution server. Alternatively, calendar 1900 may be included in a communication platform, such as Microsoft Office or Lotus Note, or a web calendar 1900. As shown in FIG. 19A, calendar 1900 includes meeting 1950.

FIG. 19B illustrates an embodiment of meeting 1950. In this regard, meeting 1950 includes From Field 1952, Attendees Field 1954, Subject Field 1956, Location Field 1958, Meeting Start Time Field 1960, Meeting End Time Field 1962, Expiration Time 1964, and Body Field 1966. According to FIG. 19B, the meeting 1950 is from “Alice Smithers” and “Bob Smith,” “Jane Doe,” and “Paul Jones” (collectively “the attendees”) will be attending. After decrypting the DSB, the meeting will tentatively be added to the attendees' calendars. In this regard, the attendees may review the meeting to determine if they will attend the meeting. Reviewing the meeting may include reviewing the meeting description in body 1966 and any attachments included therein.

If any of the attendees accept or are tentative, the meeting will remain on their calendars. However, if one of the attendees were to reject the meeting request, the meeting, and any attachments, will be deleted from their calendar. The attendees may review the meeting materials until the meeting 1950 expires. In this regard, the expiration field 1964 may begin counting down from the time when the meeting is added to the attendee's calendar. Alternatively, the expiration field may not begin counting down until the conclusion of the meeting. Accordingly, the meeting may show the time remaining until the meeting will expire. In alternative embodiments, expiration field 1964 may show the date and time that the meeting will expire.

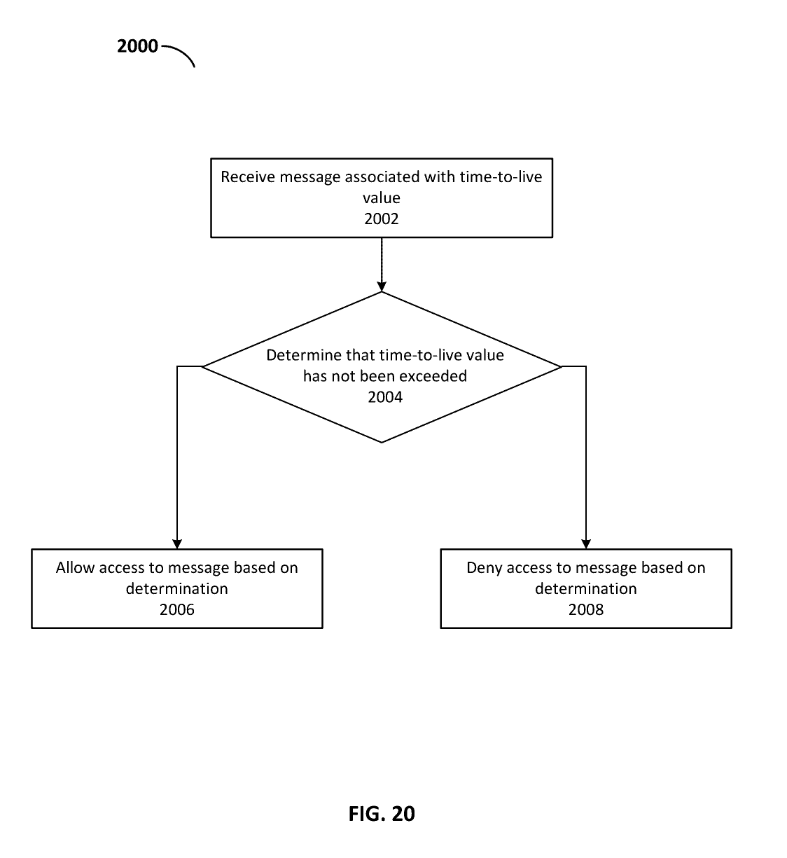

FIG. 20 illustrates an example of a process for determining whether to allow access to a message. In various embodiments, process 2000 is performed on a client device, such as Alice's client device 106. The process begins at block 2002 when a message that includes an associated TTL value is received. As noted above, the TTL value may be stored in the recipient's device's secure database in order to prevent tampering of the TTL value by the recipient. Next, a determination is made as to whether the TTL has been exceeded in block 2004. If the TTL has not been exceeded, the message is made available to the recipient in block 2006. As one example, when the recipient initially opens the message, the associated TTL may be decrypted and read by the app such that the app may begin counting down. So long as the TTL has not been exceeded (e.g., 3601 seconds have elapsed since the message was opened), the recipient may continue to view the message. Once the TTL has been exceeded, the recipient will be denied access to the message in block 2008 and the message will be removed from the recipient's device.

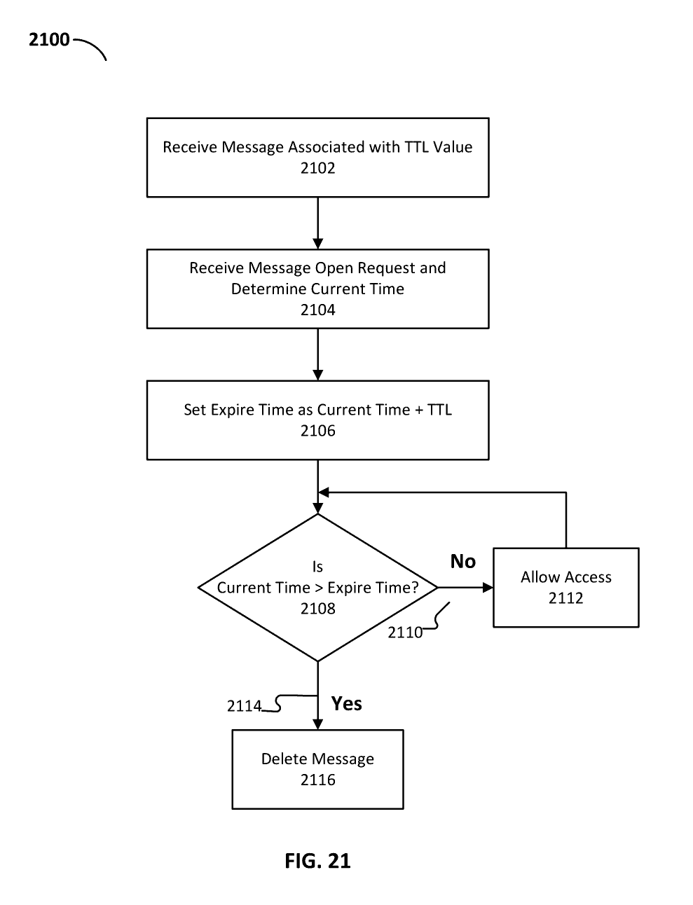

FIG. 21 illustrates an example of a process for determining whether to allow access to a message. Process 2100 is an embodiment of process 2000 and is in some embodiments performed on a client device such as Alice's client device 106. The process begins at block 2102 when a message that has an associated TTL value is received. At block 2104, a message open request (e.g., Alice clicking on a lock icon) is received and in response a Current Time is determined. One approach for determining a Current Time is to use the device time. However, a nefarious device user could attempt to circumvent TTL enforcement by modifying the device date, time, and/or time zone settings. A second approach for determining a Current Time is for the recipient's secure messaging app (e.g., app 116 in the case of Alice) to contact platform 102 (or another external time source, such as a dedicated time server) and obtain a Current Time from platform 102 (or the other external time source). In some embodiments, if app 116 is unable to obtain a Current Time (e.g., device 106 is in airplane mode or otherwise offline; or if platform 102 or the other external time source(s) are unreachable), Alice will be unable to open the message (until such time as app 116 is able to obtain a Current Time).

At block 2106, the message expiration time (“Expire Time”) is set as the Current Time (determined at 2104) with the TTL (e.g., 3600 seconds) added. Thus for example, when Alice opens message at 1:26 pm with a TTL value of 1 hour (3600 seconds), a Current Time is obtained from platform 102 (or another appropriate external time source), and a TTL of 3600 is added to the Current Time, resulting in an Expire Time of 2:26 pm.

Next, in block 2108, a determination is made as to whether the Current Time is greater than the Expire Time. If not (2110), Alice is able to view the message in block 2112, and after a period of time (e.g., one second elapsing), another check of the Current Time vs. the Expire Time is performed in block 2108. In various embodiments, the Current Time continues to be obtained from an external source (e.g., device 106 contacts platform 102 every second). In other embodiments, app 116 is responsible for maintaining the Current Time, at least a portion of the time, after performing an initial check with platform 102 of the Current Time upon message open. In some embodiments, if a Current Time cannot be obtained from an external source (e.g., platform 102 or another server) during the ongoing checking of portion 2108, the message will cease being available to Alice. So, for example, if Alice temporarily loses connectivity during the one hour window of time Bob has allowed her to read the message, Alice will be unable to read the message during that portion of the hour. In some embodiments, the TTL countdown continues, irrespective of whether Alice is offline, meaning that Alice will not be given additional time to view the message to compensate for the period her device lacked connectivity. Eventually (e.g., after one hour has elapsed), the Current Time will exceed the Expire Time (2114), at which point the message is deleted in block 2116.

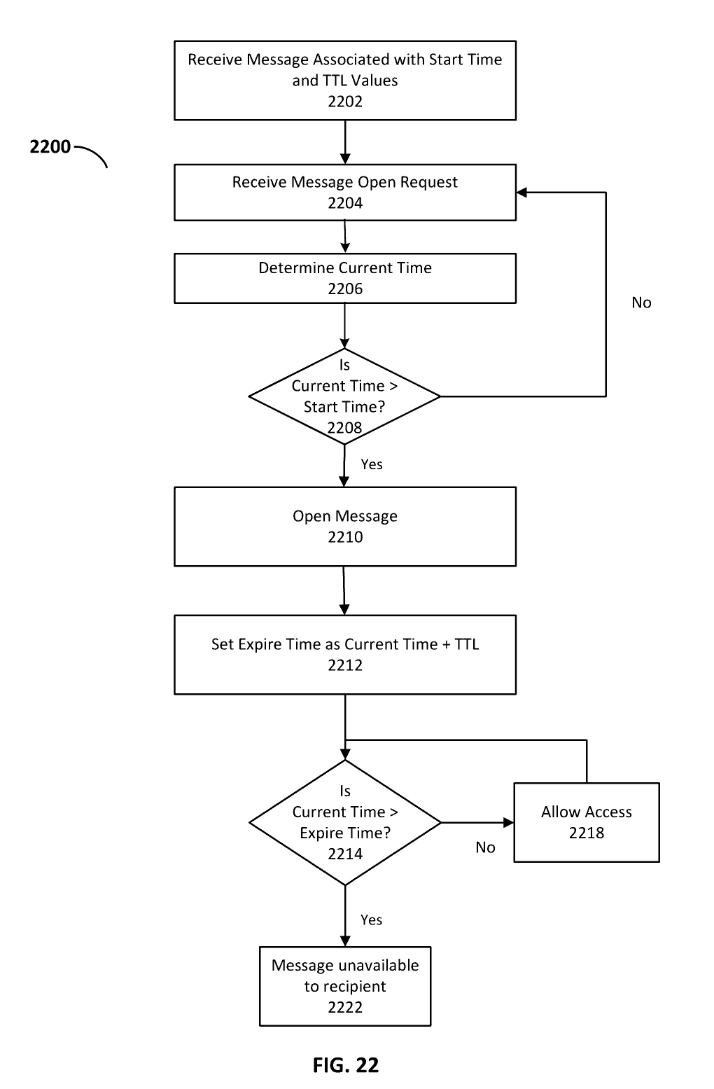

FIG. 22 illustrates another example of a process for determining whether to allow access to a message based on a received TTL value. Process 2200 is an embodiment of process 2000 and may be performed on a client device such as Alice's client device 106 in some embodiments. The process begins at block 2202 when a message that has multiple TTL-related values is received. As one example, a start time (i.e., embargo time) may be provided, as well as a duration time (e.g., 3600 seconds, as per above). Process 2200 can also be adapted to accommodate a hard end time (instead of, or in addition to a start time), as applicable.

In block 2204, the recipient's app may receive a Message Open Request. In response to the Message Open Request, the recipient's device may obtain the Current Time in block 2206 via the techniques described above. In block 2208, a determination may be made whether the Current Time exceeds the Start Time. If the Current Time does not exceed the Start Time in block 2208, the Message Open Request will be ignored since the end of the embargo has not yet been reached. In this regard, the process returns to block 2204 and periodic comparisons of the Current Time and the Start Time may be performed until the embargo ends.

If the Current Time exceeds the Start Time, then the message is opened in block 2210. The remainder of process 2200 continues as per process 2100. That is, the Current Time may be determined so the Expire Time may be set as the Current Time and TTL in block 2212. The Current Time may be periodically compared to the Expire Time in block 2214 to determine whether to continue to allow access to the message. If the Current Time does not exceed the Expire Time, then the recipient is allowed to access the message in block 2218. However, if the Current Time exceeds the Expire Time, the message may be made unavailable to the recipient in block 2222.

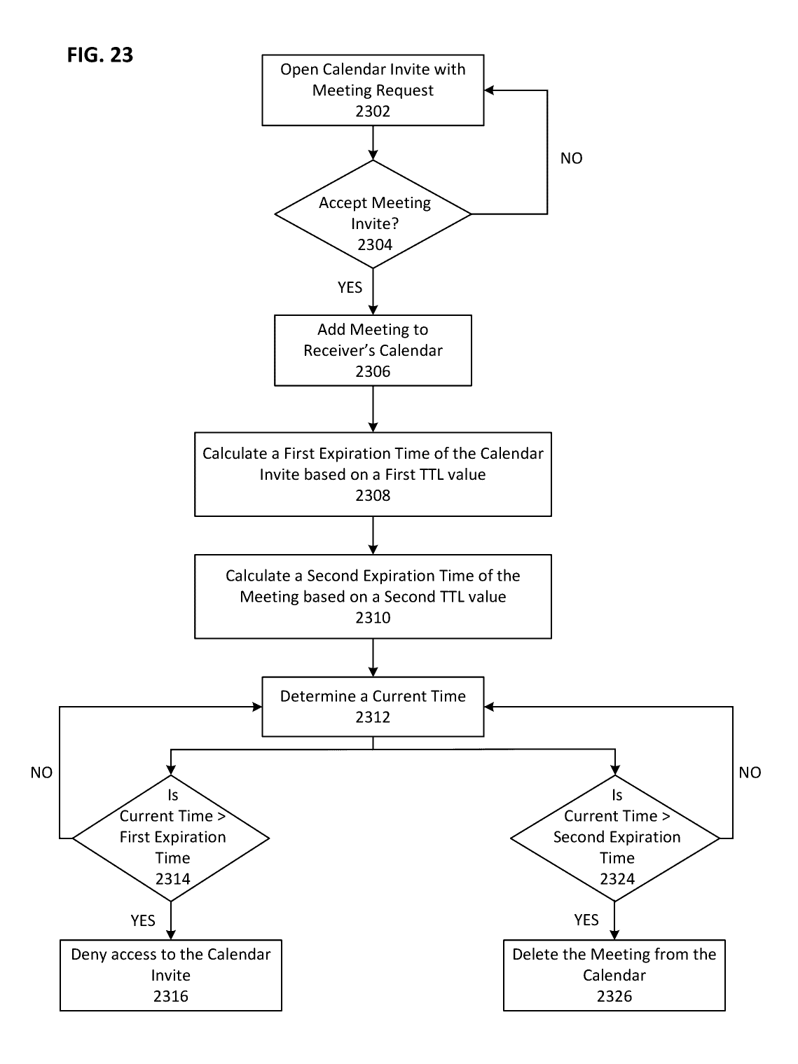

FIG. 23 illustrates a process for determining whether a calendar invite and meeting have expired. The process begins in block 2302 when a user opens a calendar invite with a meeting request. According to some embodiments, the calendar invite is an email with a meeting request included as an attachment. In alternative embodiments, the calendar invite may be an instant message, SMS message, or an MMS message with a meeting request included as an attachment. As discussed above, the communications platform may obtain a current time when the calendar invite is opened.

In block 2304, the receiver determines whether to accept the received meeting invite. The receiver may reject the meeting request, for example, if they have a conflict or do not wish to attend. In this regard, the process returns to block 2302, with the receiver waiting for calendar invites.

In some embodiments, the receiver may reject the meeting request and propose a new time. According to these embodiments, a new TTL value may be associated with the meeting request with the newly proposed time. That is, the newly proposed meeting time may be after the original TTL. Thus, the meeting request with the newly proposed time may have a different TTL value than the original meeting request.

If the receiver accepts the meeting request, a meeting, as illustrated in FIGS. 19A and 19B, is added to the receiver's calendar in block 2306. In block 2308, the receiver's communication platform will calculate a first expiration time of the calendar invite based on a first TTL value. As noted above, the first TTL value may be a certain number of hours after the calendar invite is opened, a static date and/or time set by the sender, or a static date and/or time set by an administrator.

In block 2310, the communication platform will calculate a second expiration time of the meeting based on a second TTL value. Like the first TTL value, the second TTL value may be a certain number of hours after the conclusion of the meeting, a static date and/or time set by the sender, or a static date and/or time set by an administrator.

After calculating the first and second expiration times, the communication platform may determine a current time. As discussed above, the Current Time may be obtained from platform 102 or another appropriate external time source, such as third-party time server.

In block 2314, a determination is made whether the current time exceeds the first expiration time. If the current time does not exceed the first expiration time, the process returns to block 2312. Blocks 2312 and 2314 may be repeated periodically until the current time exceeds the first expiration time. When the current time exceeds the first expiration time, access to the calendar invite is denied in block 2316. In this regard, denying access to the calendar invite may include, for example, deleting the calendar invite from the communication platform, deleting the key required to access the calendar invite, expiring the key required to access the calendar invite, or any combination thereof.

While the Current Time is being compared to the First Expiration Time, the Current Time may also be compared to the Second Expiration Time in block 2324. These comparisons may occur simultaneously or within a short period of each other.

If the current time does not exceed the second expiration time, the process returns to block 2312. Blocks 2312 and 2324 may be repeated periodically until the current time exceeds the second expiration time. Accordingly, the meeting, and any attachments included therein, may be deleted from the calendar. This may include deleting the meeting from the sender's calendar, the receiver's calendar, any calendars maintained by the server, or any combination thereof.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
determine whether a current time is greater than an expiration time associated with a message, wherein the message includes an attachment comprising a meeting request, and wherein the expiration time is determined at least in part based on a time that a meeting entry is placed on a receiver's calendar; and
delete the message when the current time is greater than the expiration time; and
a memory coupled to the processor and configured to provide the processor with instructions.

2. The system of claim 1, wherein the processor is further configured to:
calculate the expiration time by adding a time-to-live value received with the message to a time the message was viewed.

3. The system of claim 1, wherein the message is selected from the group consisting of: an e-mail, an instant message, an SMS message, a MMS message, a calendar invite, and a calendar meeting.

4. The system of claim 1, wherein the message includes a first time-to-live value.

5. The system of claim 4, wherein the processor is further configured to:
calculate the expiration time of the message by adding the first time-to-live value to a time the message was viewed.

6. The system of claim 4, wherein the message includes a second time-to-live value.

7. The system of claim 6, wherein the processor is further configured to:
calculate the expiration time of the message by adding the second time-to-live value to an end time of the meeting entry.

8. The system of claim 6, wherein the second time-to-live value is a specific date on which the meeting entry is deleted.

9. The system of claim 8, wherein the specific date is set by an administrator.

10. A method, comprising:
determining whether a current time is greater than an expiration time associated with a message, wherein the message includes an attachment comprising a meeting request, and wherein the expiration time is determined at least in part based on a time that a meeting entry is placed on a receiver's calendar; and
deleting the message when the current time is greater than the expiration time.

11. The method of claim 10, further comprising:
calculating the expiration time by adding a time-to-live value received with the message to a time the message was viewed.

12. The method of claim 10, wherein the message is selected from the group consisting of: an e-mail, an instant message, an SMS message, a MMS message, a calendar invite, and a calendar meeting.

13. The method of claim 10, wherein the message includes a first time-to-live value.

14. The method of claim 13, further comprising:
calculating the expiration time of the message by adding the first time-to-live value to a time the message was viewed.

15. The method of claim 13, wherein the message includes a second time-to-live value.

16. The method of claim 15, further comprising:
calculating the expiration time of the message by adding the second time-to-live value to an end time of the meeting entry.

17. The method of claim 15, wherein the second time-to-live value is a specific date on which the meeting entry is deleted.

18. The method of claim 17, wherein the specific date is set by an administrator.

19. A computer program product embodied in a non-transitory computer readable storage medium and comprising computer instructions for:
determining whether a current time is greater than an expiration time associated with a message, wherein the message includes an attachment comprising a meeting request, and wherein the expiration time is determined at least in part based on a time that a meeting entry is placed on a receiver's calendar; and
deleting the message when the current time is greater than the expiration time.

20. The computer program product of claim 19, further comprising computer instructions for:
calculating the expiration time by adding a time-to-live value received with the message to a time the message was viewed.

21. The computer program product of claim 19, wherein the message is selected from the group consisting of: an e-mail, an instant message, an SMS message, a MMS message, a calendar invite, and a calendar meeting.

22. The computer program product of claim 19, wherein the message includes a first time-to-live value.

23. The computer program product of claim 22, further comprising computer instructions for:
calculating the expiration time of the message by adding the first time-to-live value to a time the message was viewed.

24. The computer program product of claim 22, wherein the message includes a second time-to-live value.

25. The computer program product of claim 24, further comprising computer instructions for:
calculating the expiration time of the message by adding the second time-to-live value to an end time of the meeting entry.

26. The computer program product of claim 24, wherein the second time-to-live value is a specific date on which the meeting entry is deleted.

27. The computer program product of claim 26, wherein the specific date is set by an administrator.
